(19) United States
(12) Patent Application Publication
(10) Pub. No.: US 2025/0316707 A1
(43) Pub. Date: Oct. 9, 2025

(54) CARBON-BASED COMPOSITE MATERIAL, PREPARATION METHOD THEREFOR, AND APPLICATION THEREOF

(71) Applicant: QINGDAO HENGNENGDA ENERGY TECHNOLOGIES CO., LTD., Qingdao (CN)

(72) Inventor: Yongheng ZHANG, Qingdao (CN)

(21) Appl. No.: 19/004,673

(22) Filed: Dec. 30, 2024

Related U.S. Application Data
(63) Continuation-in-part of application No. 17/802,991, filed on Aug. 29, 2022, now abandoned.

(30) Foreign Application Priority Data
Nov. 30, 2020 (CN) 202011370284.5

(51) Int. Cl. H01M 4/66; C01B 32/162

(52) U.S. Cl. CPC H01M 4/663; C01B 32/162; H01M 4/667; C01B 2202/08; C01B 2202/22; C01B 2202/36; C01P 2004/03; C01P 2004/04; C01P 2004/13; C01P 2006/40

(57) ABSTRACT

The invention discloses a carbon-based composite material and its preparation method and application. The carbon-based composite material comprises the substrate, carbon film and structural carbon, and the carbon film or structural carbon contains alkali metal element or alkaline earth metal element. The alkali metal element or alkaline earth metal element is used as the catalyst to make the carbon source deposit the carbon film on the substrate surface and the structural carbon on the carbon film, and the substrate, carbon film and structural carbon are bonded together forming an integrated body without use of binder. The carbon film and structural carbon modify the substrate to generate the carbon-based composite material with a excellent property, and the property comprises one or more of any property of material. A use of the carbon-based composite material is any kind material in any technical field.

### CROSS-REFERENCE TO RELATED APPLICATIONS

This application is a continuation-in-part of U.S. Ser. No. 17/802,991 filed Aug. 29, 2022 which was a Rule 371 filing from PCT/CN2021/081939 filed Mar. 20, 2021, which claimed priority to Chinese Application 202011370284.5 filed Nov. 30, 2020.

### TECHNICAL FIELD

The invention belongs to the technical field of carbon-based composite material, its preparation method and application. The carbon-based composite material comprises substrate, carbon film and structural carbon. And importantly, the carbon film and structural carbon contain alkali metal element or alkaline earth metal element. The carbon-based composite material is produced by making a carbon containing source forming a carbon film on substrate surface and structural carbon on carbon film using catalyst alkali metal element or alkaline earth metal element. The use of carbon-based composite material comprises all battery and capacitor electrodes, all sensor electrodes, field emission electrodes, all solar cell electrodes, electrolytic water hydrogen production electrodes, photocatalytic hydrogen production materials, all catalysts and catalyst carriers, heat absorbing and dissipating materials, electromagnetic absorbing and emitting materials, reinforcing materials, all structural material and all functional materials, etc.

### BACKGROUND TECHNOLOGY

Carbon has three isomers, namely diamond, graphite and amorphous carbon. These kinds of carbons have different physical and chemical properties and uses. Diamond is the hardest substance known in nature. Natural diamond contains 0.0025%-0.2% nitrogen, with good thermal conductivity and semiconductor properties. (1) It has high temperature resistance, good thermal stability and does not melt at 3600° C. (2) It has good thermal conductivity. (3) It has good chemical stability and resistance to acid, alkali and organic medium erosion, so it is used to manufacture electrodes, brushes, heat exchanger, coolers, etc. In 1991, Iijima, an electron microscope expert at NEC in Japan, discovered hollow carbon fibers and carbon nanotubes.

Carbon nanotubes, diamond, graphite and C60 are allotrope of carbon. Carbon nanotube is a spiral tubular structure rolled by hexagonal reticular graphene sheet. Single wall carbon nanotubes are composed of a layer of graphene sheets, which are hundreds of nanometers to several μms or even longer. Multi-walled carbon nanotubes are made of multi-layer graphene sheets. The gap between layers is about the same as that of graphite, about 0.343 nm, with a diameter of tens of nanometers and a length of more than a few μms. Although scientist knew one atom thick, two-dimensional crystal graphene existed, no-one had worked out how to extract it from graphite. In 2004, Professor Andre Geim and Professor Kostya Novoselov isolated the graphene from graphite by using sticky tape for the very first time. The carbon has been studied as the best thermal interface material for infrared detectors, capacitor electrodes, lithium battery electrodes, solar cell electrodes, various gas sensors, biosensors and high-power integrated circuit chips.

However, in prior arts, the application of carbon needs to use a chemical called binder to physically bond the carbon material on substrate. For example, the electrode application of carbon materials needs to prepare slurry together with conductive agent carbon black and binder, and then apply the slurry to the current collector. After drying and rolling, the electrodes were produced for batteries and capacitors, gas sensor electrodes, biosensor electrodes, etc. The prepared electrode has the following defects in practical application: (1) a reduction of effective capacity of electrode, (2) a reduction of the electrical contact and increase of working resistance of electrode, (3) a large amount of heat generated in the process of charge and discharge causing the deterioration of electrical contact condition of the electrode. (4) a increases of thickness and weight of the electrode. (5) easy to combust.

### SUMMARY OF THE INVENTION

Disclosed herein is a revolutionary carbon-based composite material, which can be used in all technical fields, such as mechanical, electrical, optical, electronic, magnetic, chemistry, chemical, thermal, electromagnetic wave absorbing and emitting, semiconducting, superconducting with excellent performances compared with prior arts. Importantly, the carbon-based composite material is extremely easy to manufacture.

The carbon-based composite material comprises substrate, carbon film and structural carbon. Wherein the carbon film is chemically bonded on substrate surface and the structural carbon grows on the carbon film, and the substrate, carbon film and structural carbon are chemically bonded together forming one body. There is no binder between the substrate and carbon film. The carbon-based composite material has any shape and structure and has not size limitation. Typically, the carbon-based composite material can be produced with a surface area from 0.001 square nanometers to 1 billion square meters.

The substrate refers to the solid materials. Wherein the solid material comprises semiconductive material, conductive material or nonconductive material. Wherein the solid material comprises polymer, ceramics or metal. The substrate comprises one or more kinds of solid material. The substrate is any shape and structure, and has no size limitation. Typically, the substrate has a surface area from 0.001 square nanometers to 1 billion square meters.

The carbon film and structural carbon contains one or more of alkali metal element, or one or more of alkaline earth metal element. The alkali metal element comprises Li, Na, K, Rb, Cs or Fr, and the alkaline earth metal element comprises Be, Mg, Ca, Sr, Ba or Ra. The alkali metal element comprises any matter containing alkali metal element, and the alkaline earth metal element comprises any matter containing alkaline earth metal element.

Further, the carbon film or structural carbon contains one or more of all elements excluding carbon element, alkali metal element and alkaline earth metal element. The all elements comprise all elements in nature. Wherein the element comprises any matter containing the element.

A content of alkali metal element and alkaline earth metal element in the carbon film is 0 wt %-99.999900000000000 wt % mass of the carbon film, but not to be zero. A content of all elements excluding carbon element, alkali metal element and alkaline earth metal element in the carbon film is 0 wt %-99.999900000000000 wt % mass of the carbon film. A content of alkali metal element and alkaline earth metal element in the structural carbon is 0 wt %-99.999900000000000 wt % mass of structural carbon, but not to be zero. A content of all elements excluding carbon element, alkali metal element and alkaline earth metal element in the structural carbon is 0 wt %-99.999900000000000 wt % mass of the structural carbon.

The carbon film has a film-like shape and structure. The structural carbon has any shape and structure. The carbon film continuously or discontinuously covers the substrate.

A preparation of the carbon-based composite material is extremely simple and cost efficient. In a summary, the preparation involves utilizing a catalyst to make a carbon containing source forming the carbon film on a surface of a substrate and the structural carbon on the carbon film in an environment comprising vacuum, gas matter, liquid matter or solid matter. The catalyst comprises one or more of any matter containing alkali metal element or one or more of any matter containing alkaline earth metal element. The alkali metal element comprises Li, Na, K, Rb, Ce or Fr, and the alkaline earth metal element comprises Be, Mg, Ca, Sr, Ba, or Ra. The substate comprises one or more of all solid materials at room temperature with any shape and structure with no size limitation. All solid materials at room temperature comprise organic material, inorganic-nonmetal material and metal. The carbon containing source comprise carbon or one or more of all carbon containing organic matters. Preferably, the environment temperature is −272.99° C. to 3000° C., further preferably, the environment temperature is −272.99° C. to 2500° C. Wherein the temperature is the environment temperature rather than the temperature of the reaction site.

The carbon-based composite material can be used as any kind of material in all technical field, such as an electromagnetic wave absorption and emission material, binderless positive and negative electrode of all kind battery, positive and negative electrode materials of all kind battery, binderless electrode and electrode material of all kind capacitor, catalyst and catalyst support for all kinds of reactions, hydrogen storage material, reinforcing materials, electrical materials, all structural materials, all functional materials, electrodes of all sensors, solar cell electrodes, electrolytic water hydrogen production electrodes, photocatalytic hydrogen production materials, infrared detector electrodes, or heat exchange materials. Even, some applications have been listed above, they cannot limit the use of carbon-based composite material. In one word, the use of the carbon-based composite material is absorbing and emitting electromagnetic waves.

One of the most important characteristics of the carbon-based composite material is that the carbon film and structural carbon contain catalyst alkali metal element or alkaline earth metal element. Therefore, the catalyst is constantly reacting with the carbon film and structural carbon, suggesting a dynamically modification of the substrate generating the carbon-based composite material. The dynamic mechanism of the carbon film and structural carbon causes the dynamic nature of the matter in the carbon film, structural carbon, substrate and environment. The result is the absorbing electromagnetic wave and emitting electromagnetic wave of the carbon-based composite material. Wherein the electromagnetic wave comprises all the waves, such microwave, infrared light, star light, moon light, red light, white light, invisible light, fluorescence light, noctilucent. Further, it is confirmed that the dynamic mechanism of the carbon film and structural carbon is a fundamental of all chemical and physical property of the carbon-based composite material.

It is then clear how and why does the carbon-based composite material exhibit the chemical and physical property? The exhibited chemical and physical properties are the interaction result of the carbon film and structural carbon with surrounding media. Hence, the change of chemical and physical properties is due to the change of the characteristics of the carbon film and structural carbon. Therefore, any factor affecting the characteristics of the carbon film and structural carbon can affect the property of the carbon-based composite material, for example the catalyst type, carbon containing source, environment, reaction temperature, phases of substrate. Different phases in the substrate have different effects on the formation of carbon film and structural carbon, and hence affect the chemical and physical property of the carbon-base composite material. Different phases comprise the phase with different chemical compositions or different crystal structures, or different microstructures. Since the carbon film and structural carbon can be added other elements excluding the carbon, alkali metal element and alkaline earth metal element, the substrate can be modified by hundreds of ways to produce the carbon-based composite material with a property. Therefore, this invention opens the processing of material with know-how and know-why.

Further, the dynamic mechanism of the carbon film and structural carbon causes a constant chemical reaction of the carbon-based composite material with surrounding matter. So, the chemical reaction of the carbon-based composite material with surrounding matter is initiated and kept by the destroying and forming cycle of the carbon film and structural carbon. It is clear that the destroying and forming cycle of carbon film and structural carbon is the fundamental of catalysis and chemical reaction. Therefore, the control of the content or type of alkali metal element or alkaline earth metal element or the carbon containing source, or environment of a reaction system is essential for catalysis, chemical reaction and synthesis.

In a summary, any property of the carbon-based composite material in any environment is affected by the dynamic mechanism of the carbon film and structural carbon. Any change in property is due to the characteristic change of the carbon film and structural carbon as a result of absorbing and emitting electromagnetic waves.

### OBJECTIVES OF THE INVENTION

The objectives of my invention include but are not limited to the following:
1. The invention is to disclose a carbon-based composite material with excellent property for using in any technical field.
2. The invention is to disclose a preparation method to produce the carbon-based composite material with excellent performances in any technical field.
3. The invention is to disclose a preparation method to produce the carbon-based composite material with excellent bonding strength between the carbon film and substrate.
4. The invention is to provide a carbon-based composite material as absorbing and emitting material of the electromagnetic waves.
5. The invention is to disclose the use of the carbon-based composite material as all structural and functional materials in all technical field, such as mechanical, electrical, optical, electronic, magnetic, chemistry, chemical, thermal, electromagnetic, semiconducting, insulating, conducting, superconducting.
6. The invention is to disclose a carbon-based composite material with excellent combustion resistance at any environment.
7. The invention is to disclose a carbon-based material as electrode of battery and capacitor with better combustion resistance, higher capacity, faster charge and discharge rate, longer cycle at an environment temperature such as from −200° C. to 200° C.
8. The invention is to provide a carbon-based composite material containing lithium, sodium, potassium, rubidium, cesium and beryllium, magnesium, calcium, strontium, barium elements for battery and capacitor electrodes with not achievable property by prior arts.
9. The invention is to prepare a carbon-based composite material as positive and negative electrodes of hydrogen, lithium, sodium, potassium, rubidium, cesium, magnesium, calcium, strontium, barium ion batteries or electrode of capacitors, and improve the electrochemical performance of the electrodes, including capacity, charge and discharge, cycle, combustion resistance at an environment temperature such as from −200° C. to 200° C.
10. The invention is to provide a carbon-based composite material as various capacitor and battery electrodes with a high capacity, charge and discharge rate, cycling performance, combustion resistance.
11. The invention is to improve the bonding strength, electrical contact and thermal conductivity between the carbon film and the substrate and improve the chemical stability and combustion resistance of the electrode for using at an environment temperature from −200° C. to 200° C.
12. The invention is to provide a carbon-based composite material as an electrode with less thickness and lighter weight than prior arts.
13. The invention is to provide a carbon-based composite material with extra low electrical resistance, or superconductivity, or high strength or better combustion resistance at a temperature from −270° C. to 2500° C. in 1 atmospheric pressure.
14. The invention is to provide a carbon-based composite material as an extra low energy consumption, longer use life semiconductor.
15. The invention is to provide a carbon-based composite material as optical lens or optical fiber with wide spectrum or selected spectrum or high power at any environment such as air or dark air or space or universe at a temperature such as from −200° C. to 200° C.
16. The invention is to provide a carbon-based composite material with higher strength, or higher toughness, or higher hardness, or higher ductility, or higher fracture strength, or higher corrosion resistance or higher temperature resistance in air or river or deep sea or space or universe or other environments.
17. The invention is to provide a carbon-based composite material as antenna of wireless equipment and satellite with selectable frequency and high sensitivity and high power and long use life at any environment.
18. The invention is to provide a carbon-based composite materials as electrolytic water hydrogen production electrodes, electrodes of biosensors, gas sensors, infrared sensors and other sensors, solar cells, heat exchange materials, photocatalytic and electrolytic water hydrogen production materials, field emission and other applications with excellent performance.
19. The invention is to provide a carbon-based composite material to improve the effective specific surface area, capacity and sensitivity of the electrode.
20. The invention is to provide a carbon-based composite material as all catalyst and catalyst support and to improve their performance.
21. The invention is to prepare a carbon-based composites material as high-performance heat exchange materials for any device.
22. The invention is to provide a carbon-based composite material as reinforcing and modifying materials.
23. The invention is to provide a carbon-based composite material as a hydrogen storage material with a high storage capacity and safety.

### BRIEF DESCRIPTION OF THE DRAWINGS

FIG. 1 illustrates the schematic diagram of the carbon-based composite material produced in accordance with this disclosure.

FIG. 2 illustrates the SEM morphologies of the carbon-based composite material produced in embodiment 1 by using stainless steel as substrate and K₂CO₃ as catalyst in accordance with this disclosure. (600° C., 1 hour, acetylene) (a) magnification 2000, (b) magnification 10000, (c) magnification 50000

FIG. 3 illustrates the SEM morphologies of the carbon-based composite material produced in embodiment 1 by using stainless steel as substrate and Na₂CO₃ as catalyst in accordance with this disclosure. (600° C., 1 hour, acetylene), (a) magnification 2000, (b) magnification 10000, (c) magnification 50000

FIG. 4 illustrates the SEM morphologies of the carbon-based composite material produced in embodiment 1 by using stainless steel as substrate and Li₂CO₃ as catalyst in accordance with this disclosure. (600° C., 1 hour, acetylene), (a) magnification 1000, (b) magnification 2000, (c) magnification 10000

FIG. 5 illustrates the SEM morphologies of the carbon-based composite material produced in embodiment 1 by using stainless steel as substrate and KF as catalyst in accordance with this disclosure. (600° C., 1 hour, acetylene), (a) magnification 2000, (b) magnification 10000, (c) magnification 50000

FIG. 6 illustrates (a) TEM photos of carbon film and structural carbon formed into one body using K₂CO₃ catalyst and (b) TEM photos of carbon film and structural carbon formed into one body using Na₂CO₃ catalyst and (c) TEM photos of carbon film and structural carbon formed into one body using Li₂CO₃ catalyst in accordance with this disclosure in embodiment 1.

FIG. 7 illustrates the SEM photos of the carbon-based composite material produced in embodiment 2 by using 8 m copper foil as substrate and Li₂CO₃ as catalyst in accordance with this disclosure. (600° C., 1 hour, acetylene)

FIG. 8 illustrates the SEM photos of the carbon-based composite material produced in embodiment 2 by using 8 μm Cu foil as substrate and K₂CO₃ as catalyst in accordance with this disclosure. (600° C., 1 hour, acetylene)

FIG. 9 illustrates the SEM photos of the carbon-based composite material produced in embodiment 2 by using 20 μm aluminium foil as substrate and K₂CO₃ as catalyst in accordance with this disclosure. (600° C., 1 hour, acetylene)

FIG. 10 illustrates the SEM photos of the carbon-based composite material produced in embodiment 2 by using Si substrate and Li₂CO₃ catalyst in accordance with this disclosure. (600° C., 1 hour, acetylene)

FIG. 11 illustrates the SEM photos of the carbon-based composite material produced in embodiment 2 by using silicon substrate and Li₂CO₃/Na₂CO₃/K₂CO₃ (molar mass ratio 1:1:1) catalyst in accordance with this disclosure. (600° C., 1 hour, acetylene), (a) magnification 5000, (b) magnification 2000 TEM

FIG. 12 illustrates the SEM photos of the carbon-based composite material produced in embodiment 3 by using stainless steel as substrate and NaBr as catalyst in accordance with this disclosure. (600° C., 1 hour, acetylene), (a) magnification 20000, (b) magnification 50000

FIG. 13 illustrates the SEM photos of the carbon-based composite material produced in embodiment 3 by using stainless steel as substrate and LiH₂PO₄ as catalyst in accordance with this disclosure. (600° C., 1 hour, acetylene), (a) magnification 20000, (b) magnification 50000

FIG. 14 illustrates the SEM photos of the carbon-based composite material produced in embodiment 4 by using silicon as substrate and Na₂CO₃/LiCl (molar mass ratio 1:2) as catalyst in accordance with this disclosure. (650° C., 1 hour, acetylene), (a) magnification 20000, (b) magnification 60000

FIG. 15 illustrates the SEM photos of the carbon-based composite material produced in embodiment 5 by using Si as substrate and K₂CO₃/Na₂CO₃ (molar mass ratio 1:1) as catalyst in accordance with this disclosure. (650° C., 1 hour, acetylene), (a) magnification 3000, (b) magnification 30000

FIG. 16 illustrates the SEM photos of the carbon-based composite material produced in embodiment 6 by using Si as substrate and CH₃COONa as catalyst in accordance with this disclosure. (650° C., 1 hour, acetylene), (a) magnification 10000, (b) magnification 50000

FIG. 17 illustrates the SEM photos of the carbon-based composite material produced in embodiment 6 by using silicon as substrate and C₆H₅O₇Na₃·2H₂O as catalyst in accordance with this disclosure. (650° C., 1 hour, acetylene), (a) magnification 5000, (b) magnification 30000

FIG. 18 illustrates the SEM photos of the carbon-based composite material produced in embodiment 7 by using silica as substrate and KHCO₃:NaHCO₃:Li₂CO₃=1:8:1 (molar mass ratio) as catalyst in accordance with this disclosure. (600° C., 1 hour, acetylene), (a) magnification 1000, (b) magnification 5000

FIG. 19 illustrates the SEM photos of the carbon-based composite material produced in embodiment 7 by using the silica as substrate and KHCO₃:NaHCO₃:Li₂CO₃=8:1:1 (molar mass ratio) as catalyst in accordance with this disclosure. (600° C., 1 hour, acetylene), (a) magnification 5000, (b) magnification 20000

FIG. 20 illustrates the SEM photos of the carbon-based composite material produced in embodiment 7 by using silica as the substrate and KHCO₃:NaHCO₃:Li₂CO₃=1:1:8 (molar mass ratio) as catalyst in accordance with this disclosure. (600° C., 1 hour, acetylene), (a) magnification 600, (b) magnification 1000

FIG. 21 illustrates SEM photos of the carbon-based composite material produced in embodiment 8 by using Si as substrate and KHCO₃:NaHCO₃:Li₂CO₃=1:8:1 (molar mass ratio) as catalyst in accordance with this disclosure. (600° C., 1 hour, acetylene), (a) magnification 5000, (b) carbon film and structural carbon formed in one body

FIG. 22 illustrates SEM photos of the carbon-based composite material produced by using Si substrate and KHCO₃:NaHCO₃:Li₂CO₃=8:1:1 (molar mass ratio) catalyst in embodiment 8 in accordance with this disclosure (600° C., 1 hour, acetylene), (a) magnification 2000, (b) magnification 10000.

FIG. 23 illustrates the SEM photos of the carbon-based composite material produced by using silicon substrate and KHCO₃:NaHCO₃:LiNO₃=8:1:1 (molar mass ratio) catalyst in embodiment 9 in accordance with this disclosure (650° C., 2 hour, acetylene), (a) magnification 500, (b) cross section view of structural carbon, (c) carbon film and structural carbon formed in one body, (d) carbon film and structural carbon formed in one body.

FIG. 24 illustrates the SEM photos of the carbon-based composite material produced by using silicon substrate and KHCO₃:NaHCO₃:CsNO₃=8:1:1 (molar mass ratio) catalyst in embodiment 9 in accordance with this disclosure (650° C., 2 hour, acetylene), (a) magnification 5000, (b) magnification 30000.

FIG. 25 illustrates the SEM photos of the carbon-based composite material produced by using 8 μm Cu foil as substrate and CaCl₂ as catalyst in embodiment 10 in accordance with this disclosure (600° C., 1 hour, acetylene), (a) magnification 1000, (b) magnification 3000.

FIG. 26 illustrates the SEM photos of the carbon-based composite material produced by using 8 μm Cu foil and 50 μm stainless-steel foil as the substrate and K₂CO₃ as catalyst in embodiment 11 in accordance with this disclosure. (630° C., 1 hour, methane), (a) stainless steel substrate, magnification 10000, (b) stainless steel substrate, magnification 80000. (c) Cu substrate, magnification 1000, (d) Cu substrate, magnification 6000.

FIG. 27 illustrates the SEM photos of the carbon-based composite material produced by using the 8 μm copper foil and 50 μm stainless steel foil as substrates, and LiCl/Fe(NO₃)₃ and LiH₂PO₄/Fe(NO₃)₃ as catalyst in embodiment 12 in accordance with this disclosure. (600° C., 1 hour, acetylene), (a) Cu substrate and LiCl/Fe(NO₃)₃ catalyst, magnification 10000, (b) Cu substrate and LiCl/Fe(NO₃)₃ catalyst, magnification 100000, (c) stainless steel substrate and LiH₂PO₄/Fe(NO₃)₃ catalyst, magnification 10000, (d) stainless steel substrate and LiH₂PO₄/Fe(NO₃)₃ catalyst, magnification 100000.

FIG. 28 illustrates the SEM photos of the carbon-based composite material produced by using 8 μm copper foil as substrate and MgCl₂ as catalyst in embodiment 13 in accordance with this disclosure. (550° C., 1 hour, acetylene), (a) magnification 2000, (b) magnification 5000

FIG. 29 illustrates the SEM photos of the carbon-based composite material produced in embodiment 14 by using 20 μm nickel foil as the substrate and MgCl₂ as the catalyst in accordance with this disclosure. (530° C., 1 hour, toluene), (a) magnification 10000, (b) magnification 30000

FIG. 30 illustrates the SEM photos of the carbon-based composite material produced in embodiment 15 by using 20 μm nickel foil as substrate, and MgCl₂/CaCl₂ (mass ratio 1:1) as catalyst in accordance with this disclosure. (530° C., 1 hour, acetylene), (a) magnification 5000, (b) magnification 20000, (c) TEM, magnification 4000, (d) TEM, magnification 4000

FIG. 31 illustrates the SEM photos of the carbon-based composite material produced in embodiment 16 by using 20 μm nickel foil as substrate, and Ba(NO₃)₃ as catalyst in accordance with this disclosure. (530° C., 1 hour, toluene), (a) magnification 10000, (b) magnification 30000

FIG. 32 illustrates the SEM photos of the carbon-based composite material produced in embodiment 17 by using 8 μm copper foil as substrate and Ba(NO₃)₃/LiCl/FeCl₃ (mass molar ratio 1:10:0.1) as catalyst mixture and AlPO₄ as additive in accordance with this disclosure. (550° C., 1 hour, acetylene), (a) magnification 5000, (b) magnification 10000

FIG. 33 illustrates the SEM photos of the carbon-based composite material produced in embodiment 18 by using graphite paper as substrate and Ba(NO₃)₃/LiCl/FeCl₃ (mass molar ratio 1:10:0.1) as catalyst mixture in accordance with this disclosure. (550° C., 1 hour, acetylene), (a) magnification 5000, (b) magnification 10000

FIG. 34 illustrates the SEM photos of the carbon-based composite material produced in embodiment 19 by using 8 μm copper foil as substrate and Ba(NO₃)₃/LiCl/FeCl₃ (mass molar ratio 1:10:0.1) as catalyst mixture in accordance with this disclosure. (550° C., 1 hour, acetylene), (a) magnification 10000, (b) magnification 50000

FIG. 35 illustrates the SEM photos of the carbon-based composite material produced in embodiment 20 by using titanium foil as substrate and LiCl as catalyst in accordance with this disclosure. (550° C., 1 hour, acetylene), (a) magnification 10000, (b) magnification 50000

FIG. 36 illustrates the SEM and TEM photos of the carbon-based composite material produced in embodiment 21 by using CoO as substrate, LiCl/FeCl₃ as catalyst mixture in accordance with this disclosure. (600° C., 1 hour, polypropylene), (a) magnification 10000, (b) magnification 50000, (c) TEM magnification 8000, (d) TEM magnification 80000

FIG. 37 illustrates the SEM and TEM photos of the carbon-based composite material produced in embodiment 22 by using Al₂O₃ as substrate, LiCl/FeCl₃ as catalyst mixture in accordance with this disclosure. (600° C., 1 hour, vegetable oil), (a) magnification 2000, (b) magnification 10000, (c) TEM magnification 20000, (d) TEM magnification 250000

FIG. 38 illustrates the SEM photos of the carbon-based composite material produced in embodiment 23 by using Al₂O₃ as substrate and LiCl/CuCl₂/Ni(CH₃COO)₂ as catalyst mixture in accordance with this disclosure. (500° C., 1 hour, acetylene)), (a) magnification 5000, (b) magnification 20000

FIG. 39 illustrates the SEM photos of the carbon-based composite material produced in embodiment 24 by using CaCO₃ as substrate and catalyst in accordance with this disclosure. (600° C., 1 hour, acetylene)), (a) magnification 2000, (b) magnification 50000 FIG. 40 illustrates the charge and discharge curves of the cell assembled by using (a) lithium foil and (b) composite material as the anodes and LiFePO₄ as the cathode, (c) photo of the composite material produced at 650° C. by using LiCl catalyst and C₂H₂ carbon source.

FIG. 41. The photo of Al substrate composite (a) and Ti substrate composite (b), the SEM photo of Al substrate composite (c) and Ti substrate composite (d), the charge and discharge curve of Al substrate composite electrode (e) and Ti substrate composite electrode (f).

### DETAILED DESCRIPTION OF THE INVENTION

The carbon-based composite material is produced by forming the carbon film on a substate surface and the structural carbon on the carbon film. The carbon film is chemically bonded on the substrate surface and the structural carbon is chemically bonded to the carbon film. The substrate, carbon film and structural carbon form an integrated structure. There is no chemical binder between the carbon film and the substrate. Wherein the carbon film has a film-like structure, and its microstructure or chemical composition is homogeneous or nonhomogeneous. Wherein the structural carbon has any shape and structure, and its microstructure or chemical composition is homogeneous or nonhomogeneous. The carbon-based composite material has any shape and structure and has no limitation on size. Typically, a carbon-based composite material with a surface area from 0.001 square nanometers to 1 billion square meters can be produced for use, wherein the carbon-based composite material with a surface area of 0.001 square nanometers comprises ionized atoms and the carbon-based composite material with a surface area of 1 billion square meters comprising porous, aerogel, or thin film structure.

Further, the carbon film can continuously or discontinuously cover the substrate surface. A discontinuous covering the substrate surface can be achieved by applying the catalyst discontinuously on the substrate surface. Alternatively, different carbon films or structural carbons can be formed on the surface of different phases of the substrate, wherein the different phases can be different in chemical composition or crystal structure. The structural carbon can be any shape and structure. Typically, the carbon film has an average thickness from 0.001 nm to 1 mm.

The carbon film and structural carbon contains carbon and one or more of alkali metal element or one or more of alkaline earth metal element.

Further, the carbon film or structural carbon contain one or more of all elements excluding carbon element and alkali metal element and alkaline earth metal element. The all elements comprise all elements in nature.

Wherein the alkali metal element comprises any matter containing alkali metal element, the alkaline earth metal element comprises any matter containing alkaline earth metal element, and the element comprises any matter containing the element.

Wherein the content of alkali metal element and alkaline earth metal element in the carbon film is 0 wt %-99.999900000000000 wt % mass of the carbon film, but not to be 0 and the content of all elements excluding carbon element, alkali metal element and alkaline earth metal element in the carbon film is 0 wt %-99.999900000000000 wt % mass of the carbon film.

Wherein the content of alkali metal element and alkaline earth metal element in the structural carbon is 0 wt %-99.999900000000000 wt % mass of the structural carbon, but not to be 0, and the content of all elements excluding carbon element, alkali metal element and alkaline earth metal element in the structural carbon is 0 wt %-99.999900000000000 wt % mass of the structural carbon.

The carbon film and structural carbon with 99.9999 wt % of carbon element can be produced by coating KCl catalyst on Si substrate, followed by inletting high purity CH₄ at 700° C. in a furnace. The carbon film and structural carbon with 99.9999 wt % of alkali metal element or alkaline earth metal element can be produced by coating Li metal catalyst by evaporation on LiNbO₂ crystal substrate followed by inletting a high purity CH₄ at 200° C. in a furnace.

The substrate comprises one or more kinds of solid material at room temperature. The solid material comprises polymer, ceramics or metal. Examples of metal are copper, aluminum, nickel, iron, lithium, magnesium, aluminum alloy, steel, stainless steel, alloy, copper nickel plating. Examples of ceramics are alumina, zinc oxide, glass, silicon, silicon dioxide, silicon carbide, lithium niobate, potassium dihydrogen phosphate, gallium oxide. Examples of polymer are polyethylene, nylon, polyvinyl chloride, polystyrene, polyvinylidene fluoride, styrene-butadiene rubber. The substrate can be any shape and structure, such as particle, fiber, film, plate, block, solid, porous, interconnecting network and woven network structure. There is no size limitation for the substrate of the carbon-based composite material. In practical, a surface area of the substrate can be from 0.001 square nanometers to 1 billion square meters. The substrate with a surface area of 0.001 square nanometers comprises ionized atoms, while the substrate with a 1 billion square meters comprises porous or aerogel or thin film substrate. Clearly, the microstructure of substrate has a profound effect on the characteristic of carbon film and structural carbon. For example, whether the substrate is crystalline or non-crystalline, polycrystalline or single crystal, single phase or multiphase or different chemical composition having different effects on the formation of carbon film and structural carbon. Therefore, one or more kind of carbon film and structural carbon can be produced on substrate. Important to note, the boundary between carbon film can be more active for chemical reaction than other places. It is then clear that the manipulation of microstructure of substrate material can manipulate the characteristic of carbon film and structural carbon, so that to produce the carbon-based composite material with a required property.

The preparation method of the carbon-based composite material is extremely simple, cheap and easy without any burden to use for skilled person. The preparation method comprises utilizing a catalyst to make a carbon containing source form the carbon film on a surface of substrate and the structural on carbon film in an environment comprising vacuum, gas matter, liquid matter or solid matter; wherein the catalyst comprises one or more of any matter containing alkali metal element or one or more of any matter containing alkaline earth metal element; wherein the carbon containing source comprises carbon or one or more of any matter containing organic matter, wherein the gas matter comprises any matter in gas state, the liquid matter comprises any matter in liquid state, and the solid matter comprises any matter in solid state. The alkali metal element comprises Li, Na, K, Rb, Cs or Fr, and the alkaline earth metal element comprises Be, Mg, Ca, Sr, Ba or Ra.

Examples of the catalyst are elementary substances, organic compounds or inorganic compounds of alkali metals or alkaline earth metals, or their mixture. More detail examples are Li, LiCl, Li₂CO₃, LiOH, LiH₂PO₄, LiF, lithium acetate, lithium citrate, butyl lithium, phenyl lithium, lithium stearate, lithium palmitate, NaCl, Na₂CO₃, NaOH, NaF, sodium ethanol, sodium methoxide, sodium formate, sodium acetate, sodium citrate, KCl, K₂CO₃, KOH, KF, K₃PO₄, potassium oxalate, potassium hydrogen phthalate, RbCl, RbNO₃, rubidium acetate, rubidium oxalate, CsCl, Cs₂CO₃, CaCO₃, Ca(OH)₂ CaCl₂), calcium gluconate, calcium lactate, calcium acetate, magnesium acetate, magnesium gluconate, MgCl₂, MgO, MgSO₄, SrCl₂, SrO, strontium gluconate, strontium acetate, barium acetate, barium citrate, BaCl₂, BaCO₃ and BaSO₄.

In some embodiments, the catalyst is prepared into a catalyst mixture comprising gas, solution, suspension, paste, powder or solid of the catalyst. The solution, suspension or paste is organic-based, inorganic-based or organic and inorganic based, such as water-based, ethanol-based, acetone-based, or water and ethanol mixed-based, acetone and ethanol-based. Preferably, the content of the catalyst in the catalyst mixture is 0.00000000001 wt %-99.99 wt %.

In some embodiments, the additive is added into the catalyst mixture for producing the carbon film, or structural carbon or the carbon-based composite material. Preferably, the content of additive is 0.00000000001 wt %-99.9999 wt %. The additive comprises one or more of all materials, and the all material comprises simple substance, organic material or inorganic material, or metallic material. In addition, the additive can act as a thickener or surfactant for the mixture of solution, suspension, paste. The organic material containing carbon element acts as a carbon containing source for producing the carbon film and structural carbon. The organic material examples are polyvinyl alcohol, polyethylene, phenolic resin. The inorganic material examples are CuO, FeCl₂, Fe(OH)₃, CuCl₂, ZnSO₄, Al₂O₃, Fe₂O₃, TiO₂ and ZnO₂. Metallic material examples are Cu, Ni, Fe, Mn, Cr and Fe—Ni alloy. In some embodiments, the additives can react with the catalyst. For example, the additive FeCl₂ and PVA are added to the catalyst LiH₂PO₄ solution to prepare a catalyst mixture followed by coating the mixture on to a Al₂O₃ particle and heat treatment at 700° C. for 0.5-4 hours in an environment containing CH₄ to produce a carbon-based composite with the substrate Al₂O₃ covered by the carbon film and structural carbon containing lithium element and LiFePO₄ as cathode material of high charge and discharge rate, high cycle and combustion resistance at low and high temperature.

In some embodiments, the catalyst is added into organic material, inorganic nonmetallic material or metal by any means for material manufacture to produce a substrate containing catalyst. For example, 0.001 wt %-15 wt % Li metal can be added into Al metal or Cu metal, 0.001 wt %-15 wt % Mg or Ca metal can be added into Fe—C or Ni—Fe—Cr alloy, 0.001 wt %-15 wt % Li or K or Na or Ca element can be added into SiO₂, 0.000001 wt %-5 wt % Li or K or Na or Ca element can be added into Si material, 0.001 wt %-35 wt % Li or K or Na or Ca or Mg element can be added into PVDF, PVC, SBR, PE, PP, EP, PA or PS by LiCl, lithium acetate, K₃PO₄, sodium acetate, calcium gluconate, CaO, or magnesium acetate. The substrate containing catalyst can act as the catalyst or the substrate, and the substrate containing organic carbon can act as the carbon containing source, further, for the production of the carbon-based composite material.

In some embodiments, the catalyst is added into carbon containing source. For example, 0.0000001 wt %-99.99 wt % KOH or lithium acetate can be added into ethonal, PP, PE, PVDF or PVC to produce a carbon containing source containing catalyst for the production of the carbon-based composite material. It is worth to emphasize that the nature air is a carbon containing source containing catalyst.

In some embodiments, the preparation method comprises following steps.
(A1) The catalyst or catalyst mixture is coated on the substrate surface followed by heat treatment under an environment,
(A2) The substrate or substrate loaded with the catalyst or catalyst mixture is placed in a furnace with certain environment followed by adjusting the furnace to a temperature, preferably −272.99° C.-3000° C., and then holding the temperature for up to 1000 hours to decompose, melt or mix the catalyst mixture or let the catalyst infiltrate the substrate surface. This step is beneficial to the formation of carbon film and structural carbon with a uniform thickness and high consistency of structure and morphology in the next step.
(A3) The furnace environment is adjusted to replace the environment in the step (A2) followed by adjusting the furnace environment to a temperature, preferably −272.99° C.-3000° C., and then the environment of furnace is adjusted followed by inletting a carbon containing source into the furnace and holding the temperature for up to 1000 hours. The carbon containing source reacts under the action of catalyst to form the carbon film on a surface of the substrate and structural carbon on the surface of carbon film.
(A4) The furnace environment is adjusted and the furnace temperature is adjusted to −50° C.-100° C. to obtain the carbon-based composite material.

In some embodiments, the preparation method comprises following steps.
(B1) The substrate coated with the catalyst mixture followed by coating the carbon containing source followed by not heat treatment or heat treatment in an environment at a temperature range of −50° C.-1000° C. to prepare a reactant, or the substrate coated with the mixture of catalyst mixture and carbon containing source followed by not heat treatment or heat treatment in an environment at a temperature range of −50° C.-1000° C. to prepare a reactant, or the substrate is mixed with catalyst mixture and carbon containing source followed by not heat treatment or heat treatment in an environment at a temperature range of −50° C.-1000° C. to prepare a reactant.
(B2) The reactant is placed in the furnace with an environment, followed by adjusting the furnace temperature to −272.99° C.-3000° C. and holding the temperature for up to 1000 hours to generate the carbon film on a surface of substrate and the structural carbon on the carbon film.
(B3) The environment of furnace in the step (B2) is not adjusted or adjusted followed by adjusting the furnace temperature to −272.99° C.-3000° C. to obtain carbon-based composite material.

In some embodiments, the preparation method comprises following steps.
(C1) The substrate, the substrate coated with the catalyst mixture or the substrate coated with the catalyst mixture and the carbon containing source is placed in the furnace with an environment containing the catalyst and the carbon containing source, followed by adjusting the furnace temperature to −272.99° C.-3000° C., and then holding the temperature for up to 1000 hours to generate the carbon film on a surface of substrate and the structural carbon on the carbon film.
(C2) The environment of the furnace is not adjusted or adjusted, and the furnace temperature is adjusted to −50° C.-100° C. to obtain the carbon-based composite material.

In some embodiments, the preparation method comprises following steps.
(D1) The substrate, the substrate coated with the catalyst mixture or the substrate coated with the catalyst mixture and the carbon containing source is placed in the furnace with an environment following by adjusting the furnace temperature to −272.99° C.-3000° C. and then holding the temperature for up to 1000 hours to decompose, melt or mix the catalyst mixture and let the catalyst infiltrate the substrate surface.
(D2) The environment of furnace is adjusted followed by adjusting the furnace temperature to a temperature of −272.99° C.-3000° C., then followed by inletting the catalyst and the carbon containing source into the furnace, then adjusting the furnace temperature to −272.99° C.-3000° C. followed by holding the temperature for up to 1000 hours to generate the carbon film on a surface of substrate and the structural carbon on the carbon film.
(D3) The environment of the furnace is not adjusted or adjusted, and the furnace temperature is adjusted to −50° C.-100° C. to the obtain carbon-based composite material.

In the preparation method, when the environment required between adjacent steps is consistent, the adjustment of environment in subsequent step is omitted. The matter in the environment can participate in reaction for producing the carbon film or structural carbon or substrate.

In the preparation method, the shape of the substrate can change after reaction. For example, the film like substrate is changed to powders and the large particle substrate is changed to smaller particle. In some cases, the catalyst and additive react forming a new substrate, and the new substrate is a substrate with different chemical composite, or with the same chemical composition but different morphologies or microstructures.

In the preparation method, all steps can be carried out under a mechanical pressure or atmospheric pressure.

In the preparation method, the substrate to be coated can be cleaned by various methods, such as chemical cleaning and physical cleaning, so as to eliminate the influence of surface covering on the manufacturing process. The chemical cleaning agent includes ethanol, acetone, xylene, formaldehyde, organic solvents, deionized water or surfactant. After cleaning, the substrate shall be dried in any suitable environment such as vacuum, air, nitrogen, various organic or inorganic gases, or mixed gases. Herein, the heat treatment temperature can be −50° C.-1000° C., and the heat treatment time is up to 1000 hours. Further preferably, the heat treatment temperature is −50° C.-700° C.

In the preparation method, the catalyst mixture is coated on the substrate by any realizable methods, such as spraying, dipping, wiping, scraping, brushing, drenching, wiping, roller coating, printing, sputtering, chemical vapor deposition, physical vapor deposition. The coated substrate is then dried in any possible environment, such as vacuum, air, oxygen, inert gas, hydrogen, ammonia, inorganic gas, organic gases or various mixed gases. Herein, the heat treatment temperature is preferably −50° C.-700° C., and the heat treatment time is up to 100 hours.

In the preparation method, a specific pattern of catalyst coverage on the substrate is obtained by applying a porous template, mask during coating process, or by printing. The area coated with the catalyst will be covered by the carbon film and structural carbon, while the area without coating the catalyst is not covered by the carbon film and structural carbon or is covered by a different carbon material. In some embodiments, various catalyst mixtures are coated on different surfaces of the substrate to produce a carbon-based composite material with two or more kinds of carbon films and structural carbons. This disclosure is important for producing such as semiconductor, solar cell electrode, fuel cell electrode, electrode of all sensors, electrode of battery and capacitor.

In the preparation method, the carbon containing source comprising carbon or the carbon containing organic matter. Examples of carbon containing organic matters are alcohols (such as methanol, ethanol), organic acids (such as formic acid, acetic acid, various saturated and unsaturated fatty acids), olefins, alkanes, alkynes, ketones (such as acetone), various carbonaceous gases (such as propane, methane, acetylene), or sugars (such as starch, sucrose), various resins (such as phenolic resin). The carbon containing organic matter is a gas, a liquid or a solid. The carbon containing organic matter is synthesized or derived from nature. The carbon containing organic matter can comprise the catalyst as well, for example, lithium acetate, potassium oxalate, air, animal and plant tissue, plant oil, animal oil, natural rubber.

In the preparation method, one or more of the steps can be repeated for producing the carbon-based composite material comprising the carbon-based composite or different carbon films and structural carbon as insulating material, or conductive material, semiconducting material, electrode, wherein the step parameters can be changed or not changed.

In the preparation method, the heating method refers to any method that can be realized, including electric heating, combustion heating, optical radiation heating and electromagnetic heating.

In the preparation method, the carbon-based composite obtained can be post-treated as required.

The use of the invention is extremely simple and easy without demand of further research work. There is no burden at all to use it, even for a high school graduate. In some embodiments, 0.1 wt %-2 wt % lithium acetate is added in the anode or cathode electrode formulation containing phenolic resin, polyvinylidene fluoride, polyvinyl alcohol or styrene butadiene to prepare the carbon-based composite material as anode or cathode of Li-ion battery by wet or dry process at a temperature 20° C.-500° C. Then, all property of the Li-ion battery assembled by the electrodes will be significantly improved, for example, the capacity, cyclic property, charge or discharge rate performance, combustion resistance from −200° C. to 200° C., so that to make the battery lighter, safer, last longer and more powerful.

In some embodiments, 0.01 wt %-15 wt % potassium acetate and calcium acetate is added into PVC or PE followed by coating it on A1-substrate at a temperature of 200° C. The A1-substrate carbon-based composite as an electrical wire has a lower electrical resistivity, higher mechanical strength, or combustion-resistance from −200° C. to 200° C.

In some embodiments, 0.01 wt %-15 wt % of Ca, Mg, Ba, Li or Na is added into metals such as carbon steel or stainless steel to produce a metal followed by heat treated the metal in air or methane/oxygen at a temperature from 300° C. to 1000° C. to produce the carbon-based composite material with a higher strength or better corrosion resistance or higher toughness or higher hardness or higher ductility or lower electrical resistivity or superconductivity from −272° C. to 2500° C. in air, river, sear, deep sea, out space, or universe.

In some embodiments, the carbon-based composite material as wide spectrum or selected spectrum optical lens or optical fibers are produced by coating a catalyst mixture on to the lens followed by heating at a temperature 500° C.-1500° C. in an atmosphere containing carbon containing organic matter for 5-100 minutes. Then, the optical lens or fibers will have high sensitivity for the spectrum with high power at any environment.

Compared with the Prior Arts, the Invention has Following Beneficial Effects

The carbon-based composite material is excellent in any property over prior arts. The following effects are only some examples.
1. The carbon-based composite material disclosed in this invention is used as all kind materials with better performance in all technical field, such as mechanical, electrical, optical, electronic, magnetic, chemistry, chemical, thermal, electromagnetic, semiconducting, insulating, conducting, superconducting. But the prior arts cannot achieve this goal.
2. The method disclosed in this invention can modify solid material to produce the carbon-based composite material with an excellent property, and the property comprise one or more of all kind property of materials. But the prior arts cannot achieve this goal.
3. The carbon-based composite material can be used as all kind of structural and functional materials with excellent performance, wherein the carbon film is boned on substrate by chemical force, hence the strength of the bonding is higher, the electrical contact and heat exchange capacity is better. But the prior arts cannot achieve this goal.
4. The carbon-based composite material disclosed in the invention is used as electromagnetic wave absorption and emission material with excellent property. But the prior arts cannot achieve this goal.
5. The carbon-based composite material in the invention as electrical conductor with low electrical resistivity or superconductivity at an environment temperature from such as −200° C. to 200° C. in 1 atmospheric pressure. But the prior arts cannot achieve this goal.
6. The carbon-based composite material disclosed in this invention has better combustion resistance. But the prior art cannot achieve this goal.
7. The carbon-based composite material as electrode has lighter weight, thinner, simpler preparation method and lower cost and better combustion resistance at an environment temperature from such as −200° C. to 200° C. But the prior arts cannot achieve this goal.
8. By adding the additive into the catalyst, this disclosure can prepare the carbon-based composite material comprising a carbon-based composite material for applications such as electrode materials, hydrogen storage materials, catalyst material, and reinforcement materials, etc. But the prior arts cannot achieve this goal.
9. This disclosure can prepare the carbon-based composite material containing Li, Na, K, Rb, Cs, Be, Mg, Ca, Sr or Ba element as the electrodes of battery and capacitor. But the prior arts cannot achieve this goal.
10. The carbon-based composite material as electrode of battery and capacitor has higher capacity, higher charge and discharge rate, higher cycle, better combustion-resistance at an environment temperature from such as −200° C. to 200° C. But the prior arts cannot achieve this goal.
11. The carbon-based composite materials prepared by this disclosure as electrodes have larger effective specific surface area, larger electrode capacity, faster reaction rate, greater photoelectric conversion efficiency and higher electrode sensitivity. But the prior art cannot achieve this goal.
12. The carbon-based composite material prepared by this disclosure can be applied to battery and capacitor electrodes, catalysts and catalyst carriers, various sensors, field emission electrodes, solar cell electrodes, electrolytic water hydrogen production electrodes, photocatalytic hydrogen production materials, infrared detector electrodes, heat exchange materials, electromagnetic wave absorption and emission materials, etc. But the prior art can not achieve this goal.
13. This carbon-based composite material has excellent hydrogen storage performance. But prior art cannot achieve this goal.
14. The combustion resistance property of the carbon-based composite material can be modified by forming the carbon film and structural carbon on substrate for all kinds of materials including electrodes of battery and capacitor. But the prior arts cannot achieve this goal.
15. The invention discloses how and why do the property of the carbon-based composite material change? But prior art cannot achieve this goal.
16. The invention discloses how to produce a carbon-based composite material with required property. But the prior arts cannot achieve this goal.
17. The invention discloses the destroying and forming cycle of the carbon film and structural carbon. But the prior arts cannot achieve this goal.
18. The invention disclose that any property of the carbon-based composite material is affected by the carbon film and structural carbon and their destroying and forming cycle.
19. The preparation method of the carbon-based composite material is simple, cheap, easy and effective to use without any burden.

### EMBODIMENTS

The embodiments described below aims to further explain the content of the invention, but not to limit the claim extent.

The embodiments described below aims to explain the method diversity of producing the carbon-based composite material in accordance with this disclosure.

The embodiments described below aims to show the morphological diversity of the carbon-based composite material produced in accordance with this disclosure.

The embodiments described below aims to show the substrate, carbon film and structural carbon formed in one body of composite produced in accordance with this disclosure.

The embodiments described below aims to show how simple and easy to use the invention.

The embodiments described below aims to show the application of the carbon-based composite material produced in accordance with this disclosure as the electrode of lithium-ion battery, but not to limit the use of the carbon-based composite.

The carbon-based composite material is short writing as composite material in some cases.

The carbon material, carbon, carbon nanofiber and carbon nanotube described in following embodiments contain carbon element and alkali metal element or alkaline earth metal element.

### Embodiment 1

1 g K₂CO₃, Na₂CO₃, Li₂CO₃ and KF were separately dissolved into 20 g deionized water with 1 wt % surfactant (TX-100) to prepare the catalyst solution. Then, the stainless-steel foil was coated with catalyst by spraying followed by drying in an oven at 80° C. The catalyst coated stainless steel foil was then put into the tube furnace, followed by vacuuming the furnace and injecting the Ar gas. The furnace was then heated to 600° C. at a rate of 10° C./min, followed by temperature dwell for 30 min. Then, acetylene gas was inlet into the furnace at a flow rate of 100 ml/min, followed by temperature dwell at 600° C. for 1 hour. Then, the furnace was turn off followed by inletting the Ar gas into the furnace to let the furnace cool down at 10° C./min to room temperature to get the composite materials.

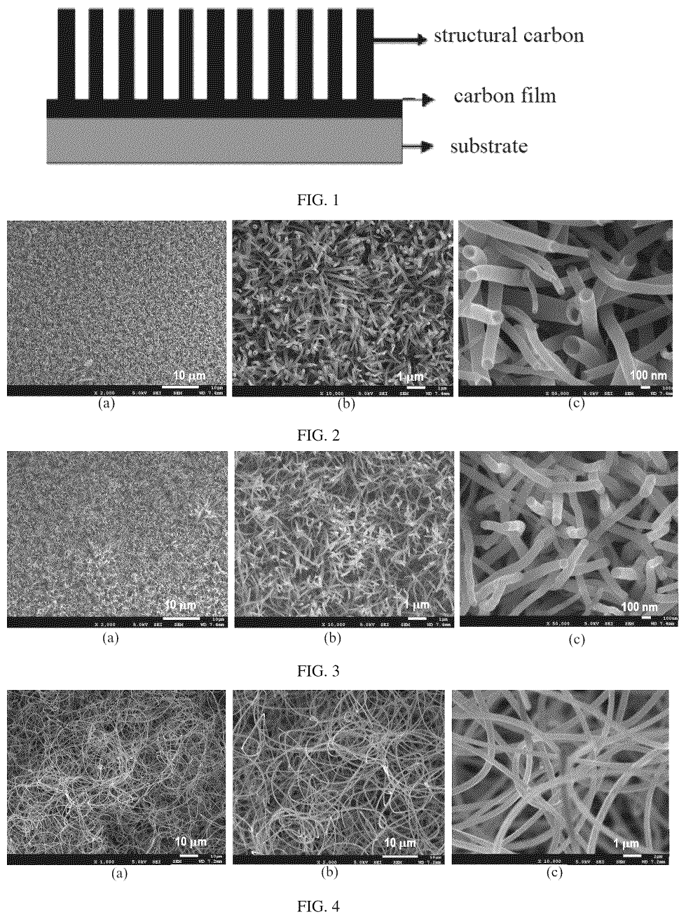

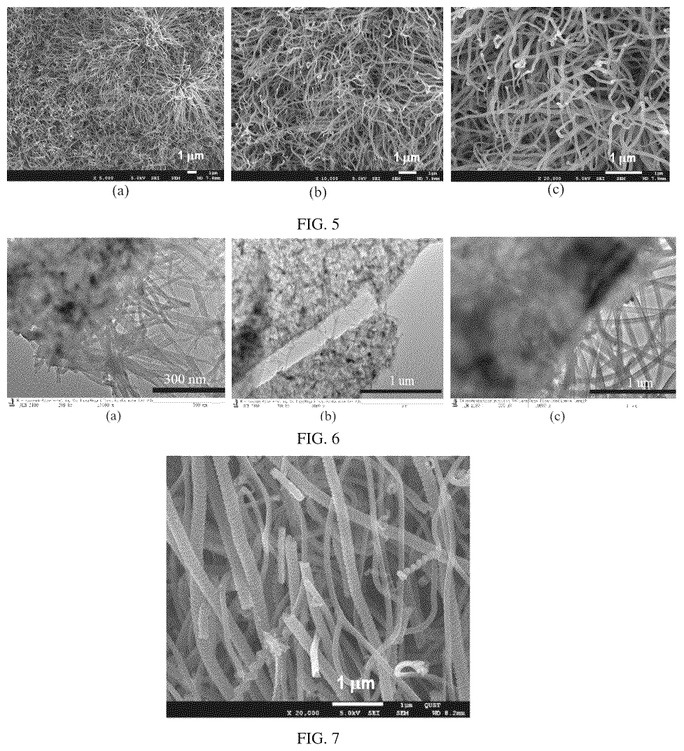

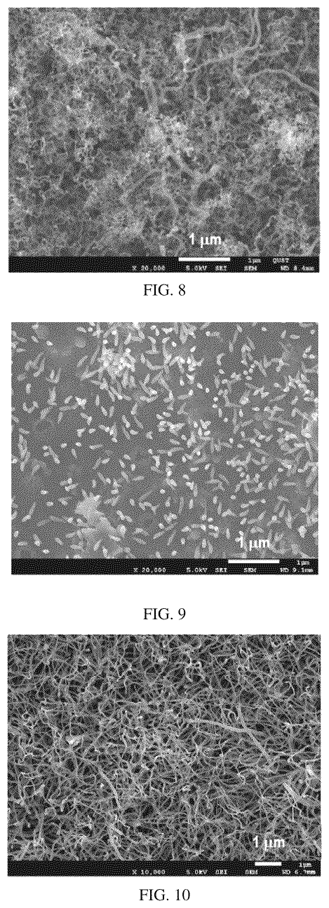

SEM (Jeol-6700) was used to examine the morphology of as fabricated composite material. The composite material fabricated by using K₂CO₃ catalyst has a structural carbon of well aligned carbon nanotube array with a fiber diameter between 100 to 200 nm as shown in FIG. 2. The composite material fabricated by using Na₂CO₃ catalyst has a structural carbon of well aligned carbon nanotube array with a uniform fiber diameter of about 150 nm, as shown in FIG. 3. The composite material fabricated by using Li₂CO₃ catalyst has a structural carbon of intertwined carbon nanotube with a fiber diameter and length of about 150 nm and 30 μm, accordingly, as shown in FIG. 4. The composite material fabricated by using KF catalyst has a structural carbon of well aligned, but slightly bended and thin-top carbon nanotube array with a fiber diameter of about 100 nm, as shown in FIG. 5. The carbon film and structural carbon are scratched away from the substrate surface using razor blade, followed by examination using TEM. FIG. 6 shows clearly that the structural carbon is consisted of carbon nanotube, which is attached to the carbon film forming into one body. It is very clear the preparation method is very simple and easy.

### Embodiment 2

1 g of K₂CO₃) and Li₂CO₃ were dissolved into 20 g of deionized water to prepare the catalyst solution. Then, the catalyst solution was sprayed on 8 μm thick copper foil, 20 μm thick aluminum foil and silicon wafer respectively, followed by drying them in a drying oven at 80° C. 0.3 g of K₂CO₃, 0.3 g of Li₂CO₃ and 0.3 g of Na₂CO₃ were dissolved into 20 g of deionized water to prepare the catalyst solution. Then, the catalyst solution was sprayed on the silicon wafer, followed by drying in a drying oven. Subsequently, the dried copper foil, aluminum foil and silicon wafer were placed in the tubular furnace, followed by vacuuming the tubular furnace and inletting argon gas, orderly. Then, the tubular furnace was heated from room temperature to 600° C. at 10° C./min, and then the acetylene gas was introduced into the tubular furnace at 100 ml/min. After reacting at 600° C. for 1 hour, the furnace was turn off and argon was introduced into the tubular furnace to let the tubular furnace cool to room temperature at 10° C./min to obtain copper substrate, aluminum substrate and silicon substrate composite materials. The obtained samples were observed by jeol-6700 scanning electron microscope. As shown in FIG. 7, the structural carbon of copper substrate composite material prepared by Li₂CO₃ catalyst is mainly spiral carbon fiber array with good orientation, and the fiber diameter is about 100 nm. FIG. 8 shows that the structural carbon of copper substrate composite material prepared by K₂CO₃ catalyst is mainly non-oriented and arbitrarily bent fibers with a fiber diameter of about 20 nm. The structural carbon of aluminum substrate composite material prepared by K₂CO₃ catalyst is carbon fibers with orientation and dispersed distribution, as shown in FIG. 9. The structural carbon of silicon substrate composite prepared by Li₂CO₃ catalyst is intertwined slender carbon nanotubes with a fiber diameter of about 20 nm, as shown in FIG. 10. The structural carbon of the silicon substrate composite materials prepared by Li₂CO₃/Na₂CO₃/K₂CO₃ mixed catalyst is a conical carbon nanotube with very good orientation, and the top diameter of the carbon nanotube is about 150 nm, as shown in FIG. 11. It is very clear the preparation method is very simple and easy.

### Embodiment 3

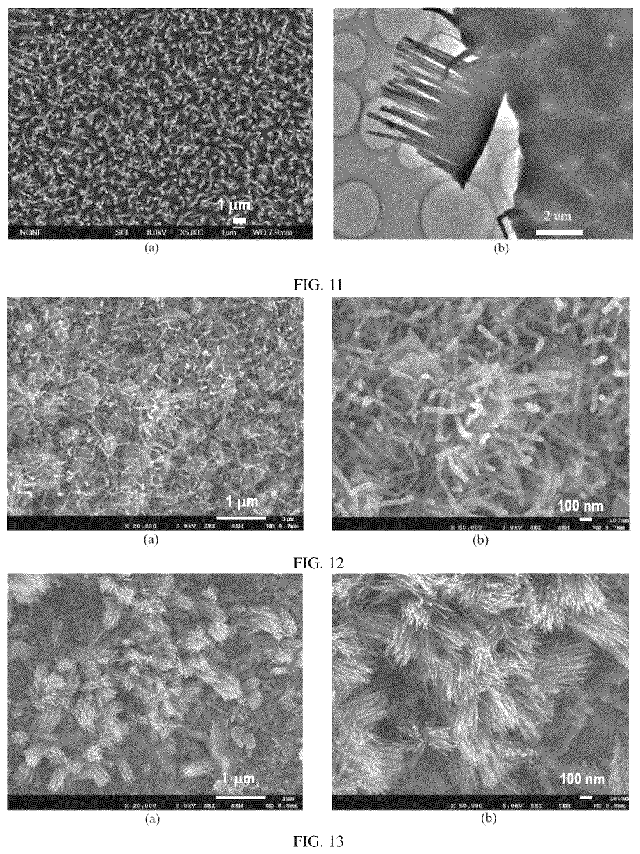

1 g sodium bromide (NaBr) and lithium dihydrogen phosphate (LiH₂PO₄) were dissolved into 20 g deionized water with 1 wt % surfactant to prepare the catalyst solution. The catalyst solution was then sprayed onto 50 m thick stainless-steel foil. The coated stainless-steel foil was dried in an 80° C. drying oven followed by placing the sample in a tubular furnace. Then, the tubular furnace was vacuumed and injected argon. The tubular furnace was heated from room temperature to 650° C. at 10° C./min followed by temperature holding of 30 minutes to ensure good contact and reaction between the catalyst and the substrate surface, so that, the thickness of the formed carbon film will be uniform, and the morphology of the formed structural carbon will be uniform. Then, the furnace temperature was reduced to 600° C., and the acetylene gas was introduced into the tubular furnace at 100 ml/min. After reacting at 600° C. for 1 hour, argon was introduced into the tubular furnace, and the tubular furnace was cooled at 10° C./min to room temperature to obtain the carbon-based composite material. The morphology of composite material was observed by jeol-6700 scanning electron microscope, as shown in FIG. 12. It can be seen from the figure that the structural carbon of the composite material prepared by NaBr catalyst is a carbon nanotube array with an opening at the top, a uniform thickness and a fiber diameter of about 50 nm. The structural carbon of the composite material prepared by lithium dihydrogen phosphate (LiH₂PO₄) catalyst consists of a clustered carbon fiber array with uniform thickness and diameter of about 5 nm, as shown in FIG. 13. It is very clear the preparation method is very simple and easy.

### Embodiment 4

5 g Na₂CO₃/LiCl (Na₂CO₃:LiCl=1:2 molar ratio) and an appropriate amount of distilled water were ground in a mortar into paste. Then, the paste catalyst is evenly coated on the silicon wafer and dried in the drying oven. The silicon wafer coated with catalyst was placed into the tubular furnace, followed by vacuuming the tubular furnace and injecting argon at a flow rate of 300 ml/min. Then, the furnace was heated to 650° C., followed by temperature dwell for 30 min. Then, acetylene was inlet into the furnace at the rate of 200 ml/min for 1 hour followed by cutting off acetylene and injecting argon to prevent oxidation of the example during cooling the furnace to room temperature at 15° C./min. The prepared silicon wafer substrate composites were observed by scanning electron microscope, as shown in FIG. 14. It is very clear the preparation method is very simple and easy.

### Embodiment 5

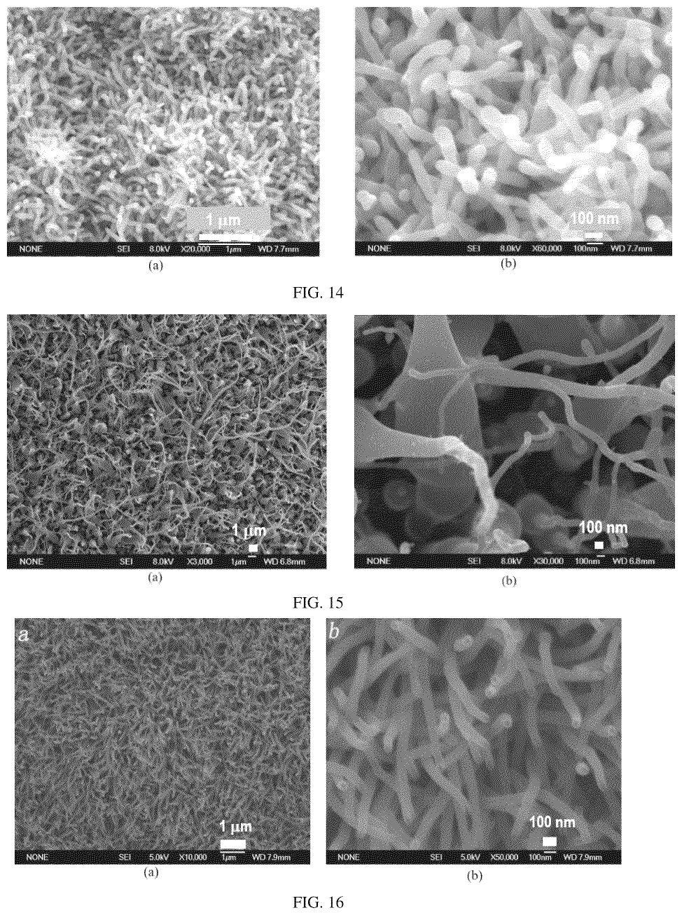

In this example, K₂CO₃/Na₂CO₃ (K₂CO₃:Na₂CO₃=1:1, molar ratio) is used as catalyst. The catalyst and appropriate amount of water were ground into paste for use. Then, the paste catalyst was evenly smeared on the silicon wafer followed by drying in the drying oven. The dried silicon wafer was heated in the tubular furnace to 650° C. in air atmosphere at a heating rate of 5° C./min followed by temperature holding time of 100 minutes. Then, argon was inlet into the furnace at a flow rate of 300 ml/min for 10 minutes. Then, acetylene was inlet into furnace for 1 hour at a flow rate of 300 ml/min until the end of the reaction. Then, acetylene was cut off and argon was inlet into furnace as protective gas to prevent oxidization by air at a flow rate of 200 ml/min. When the furnace temperature was below 30° C., Ar gas was turn off and the sample was taken out of the furnace. The morphology of composite material was observed with jeol-6700 scanning electron microscope. As shown in FIG. 15, the structural carbon consists of a curved carbon nanotube with an irregular conical structure at the bottom and a tube diameter of about 200 nm at the top. It is very clear the preparation method is very simple and easy.

### Embodiment 6

CH₃COONa (sodium acetate) and C₆H₅O₇Na₃·2H₂O (sodium citrate) were ground into powder in a mortar. Then, appropriate amount of deionized water was added into the mortar followed by grinding the chemicals into the paste. Then, the paste was applied evenly on the silicon wafer followed by drying in an 80° C. drying oven. After drying, the silicon wafer was placed into the tubular furnace followed by heating to 650° C. and temperature holding of 30 minutes. Then, the argon was inlet into the furnace at a flow rate of 300 ml/min for 10 minutes. Then, the argon was turn off followed by inletting acetylene gas at the rate of 300 ml/min for 1 hour for reaction. Then, the furnace was turned off and the flow of acetylene was cut off. Then, argon was inlet into the furnace at a gas flow rate of 400 ml/min until the furnace temperature was below 30° C. The morphology of the composite material was observed by jeol-6700 scanning electron microscope. When sodium acetate is used as the catalyst, it can be seen that the structural carbon of the composite is a well oriented carbon nanotube array, which is evenly distributed, and the diameter of carbon nanotubes is about 100 nm, as shown in FIG. 16. When sodium citrate is used as the catalyst, as shown in FIG. 17, the structural carbon nanotubes of the composite are poorly oriented, and there is an emitting head on the top of the carbon nanotube. When the sample is enlarged to 30000 times, it can be seen that the carbon nanotubes is about 250 nm in diameter with rough top and burr shape. These burr like carbon structures may be caused by the residue of catalyst on the surface of carbon nanotubes. It is very clear the preparation method is very simple and easy.

### Embodiment 7

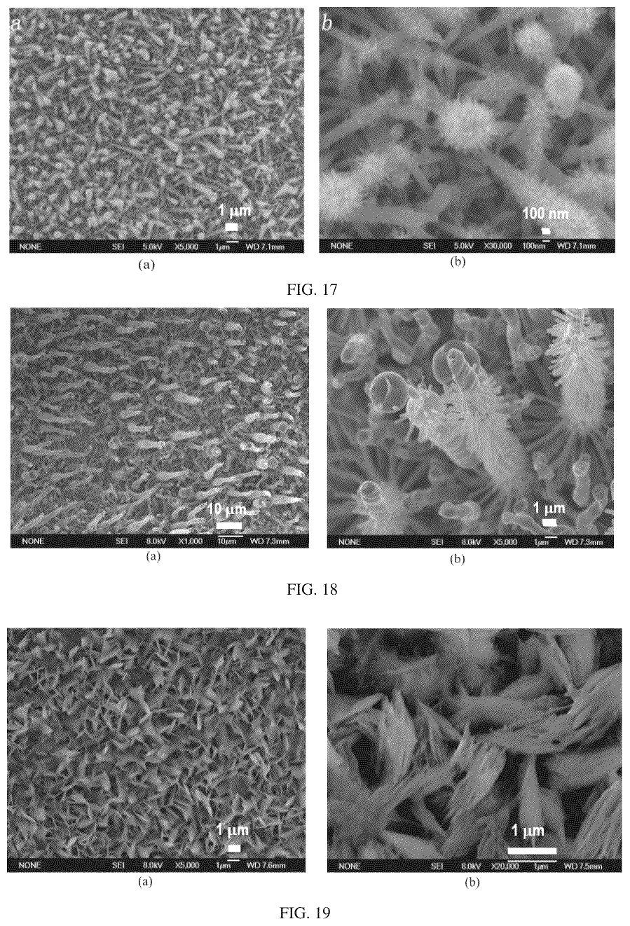

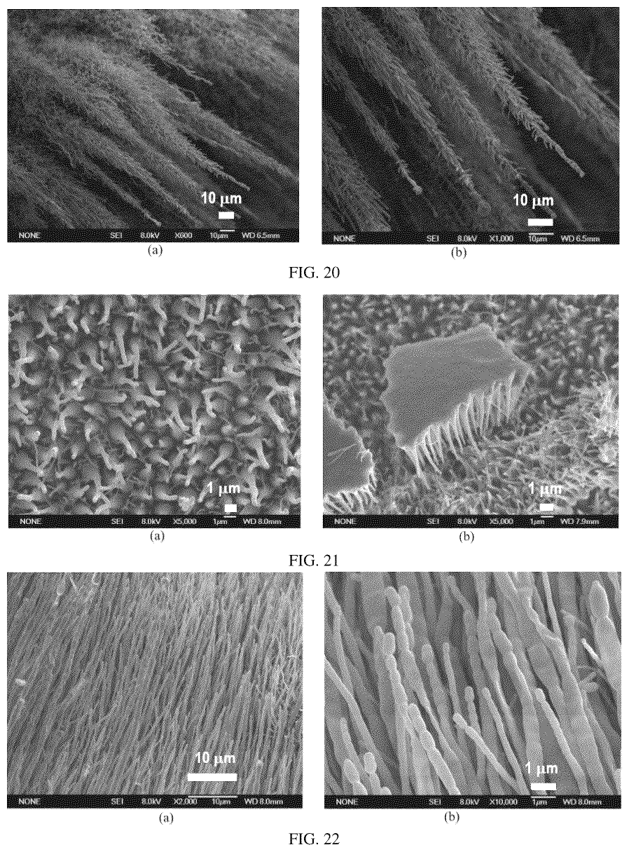

1 g KHCO₃/NaHCO₃/Li₂CO₃ (KHCO₃:NaHCO₃:Li₂CO₃=1:8:1 molar ratio), 1 g KHCO₃/NaHCO₃/Li₂CO₃ (KHCO₃:NaHCO₃:Li₂CO₃=8:1:1 molar ratio) and 1 g KHCO₃/NaHCO₃/Li₂CO₃ (KHCO₃:NaHCO₃:Li₂CO₃=1:1:8 molar ratio) were prepared. Then, an appropriate amount of water was added into the prepared chemicals followed by grinding into paste for use. Then, the paste was coated onto the quartz followed by drying in an 80° C. drying oven. Then, the dried quartz sheet was heated in a tubular furnace to 650° C. at 5° C./min, followed by temperature holding of 120 minutes. Then, argon was inlet into the furnace at a flow rate of 300 ml/min for about 10 minutes. In this step, argon gas will take away the air in the tubular furnace. Then, the furnace temperature was reduced to 600° C. followed by introducing acetylene into the furnace at the flow rate of 300 ml/min. After keeping the furnace temperature at 600° C. for 2 hours, the acetylene gas was cut off followed by introducing argon as protective gas to prevent oxidization by air at the flow rate of 200 ml/min. The furnace was then cooled to about 30° C. at a rate of 7° C./min. Finally, the argon was cut off and the sample was taken out. The morphology of composite material was observed with jeol-6700 scanning electron microscope. As shown in FIG. 18, the structural carbon of composite material prepared by catalyst with a KHCO₃:NaHCO₃:Li₂CO₃=1:8:1 is consisted of non-uniform carbon fibers with many small burr fibers on the surface of some carbon fibers. As shown in FIG. 19, the structural carbon of composite material prepared by the catalyst with a KHCO₃:NaHCO₃:Li₂CO₃=8:1:1 (molar ratio) catalyst system is like cabbage. As shown in FIG. 20, the structural carbon of composite material prepared by KHCO₃:NaHCO₃:Li₂CO₃=1:1:8 (molar ratio) catalyst system is like chrysanthemum coronarium. The research results show that the proportion of various elements in the catalyst system will greatly affect the morphology of the structural carbon of carbon-based composite material.

### Embodiment 8

1 g mixed catalyst KHCO₃/NaHCO₃/Li₂CO₃ was prepared according to KHCO₃:NaHCO₃:Li₂CO₃=1:8:1 (molar ratio). 1 g mixed catalyst KHCO₃/NaHCO₃/Li₂CO₃ was prepared according to KHCO₃:NaHCO₃:Li₂CO₃=8:1:1 (molar ratio). Then, this catalyst mixture and an appropriate amount of water were ground into paste for use. Then, the paste was evenly coated on the silicon wafer followed by drying in an 80° C. drying oven. The dried silicon wafer was heated in a tubular furnace to 650° C. in air, with a heating rate of 5° C./min and a holding time of 120 minutes. Then, argon was inlet into the furnace at a flow rate of 300 ml/min for about 10 minutes. In this step, the air in the tubular furnace is fully discharged by argon. Then, the furnace temperature was reduced to 600° C. followed by introducing acetylene to the furnace for 2 hours at a flow rate of 300 ml/min. After the reaction, the acetylene gas was cut off, and then argon was introduced to the furnace as a protective gas to prevent oxidization by air at a flow rate of 200 ml/min. The furnace was cooled to below 30° C. at the rate of 7° C./min. Then, argon was turned off and the example was taken out. The morphology of composite material was observed by jeol-6700 scanning electron microscope. As shown in FIG. 21, the structural carbon of composite material prepared with KHCO₃:NaHCO₃:Li₂CO₃=1:8:1 (molar ratio) catalyst system consists of conical carbon with good orientation and a small amount of carbon nanotubes. These structural carbon and carbon film form an integrated structure. As shown in FIG. 22, the structural carbon of composites prepared by KHCO₃:NaHCO₃:Li₂CO₃=8:1:1 (molar ratio) catalyst system has leek shape with good orientation.

### Embodiment 9

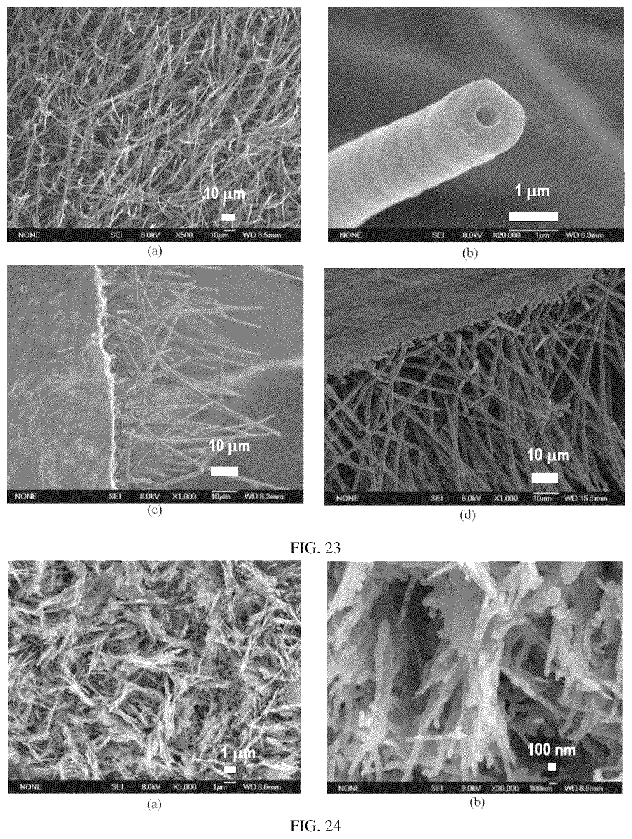

1 g mixed catalyst with KHCO₃:NaHCO₃:LiNO₃=8:1:1 (molar ratio) and 1 g mixed catalyst with KHCO₃:NaHCO₃:CsNO₃=8:1:1 (molar ratio) were prepared. Then, these mixed catalysts were added an appropriate amount of water followed by grinding them into paste for use. The paste catalyst was evenly coated on the silicon wafer followed by drying in an 80° C. drying oven. Then, the dried silicon wafer was placed in a tubular furnace followed by heating to 650° C. at a heating rate of 5° C./min. After temperature holding for 100 minutes, argon was introduced into the furnace at a flow rate of 300 ml/min for 10 minutes. Then, acetylene was inlet into the furnace for 2 hours at a flow rate of 300 ml/min. After the reaction, the acetylene gas was turned off and the argon was introduced at a flow rate of 200 ml/min as protective gas to prevent oxidation by air. When the furnace temperature was below 30° C., Ar gas was cut off and the sample was taken out. The morphology of composite material was observed by jeol-6700 scanning electron microscope. As shown in FIG. 23, the structural carbon of composite material deposited with KHCO₃:NaHCO₃:LiNO₃=8:1:1 catalyst system is dendritic carbon tubes, which grow on the carbon film forming an integrated structure, and the thickness of the carbon film is about 800 nm. As shown in FIG. 24, the structural carbon of composite material prepared with KHCO₃:NaHCO₃:CsNO₃=8:1:1 (molar ratio) catalyst system is difficult to describe the shape in language. The great difference of the shape of the two composites is due to the difference of one catalyst.

### Embodiment 10

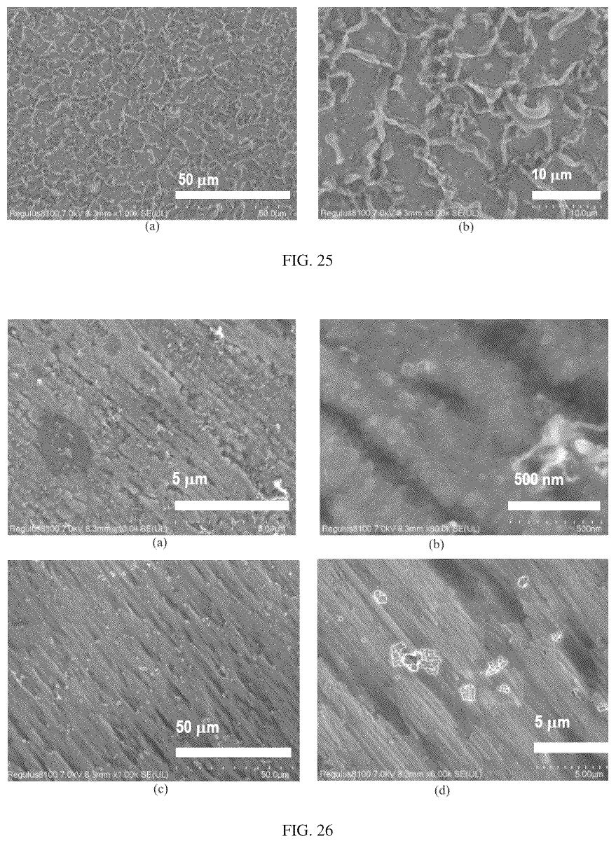

2 g CaCl₂ was dissolved into 38 g deionized water containing 0.1% surfactant TX-100 to prepare a catalyst mixture. Then, the 8 μm thick copper foil was evenly sprayed with the catalyst mixture followed by drying in a dry oven at 80° C. for 20 minutes. Then, the sample was placed in a heating furnace followed by vacuuming the heating furnace and injecting acetylene gas. Then, the furnace was heated from room temperature to 600° C. (heating time 45 minutes) followed by temperature holding of 1 hour. Finally, the power supply was turned off to let the furnace cool naturally to 50° C., and then the sample was taken out. The morphology of the sample was observed by scanning electron microscope, and the results are shown in FIG. 25. It can be seen from the figure that the structural carbon of the composite material has an irregular steep protrusion with a width of about 1 m.

### Embodiment 11

2 g K₂CO₃ was dissolved into 38 g deionized water containing 0.1% surfactant TX-100 to prepare a catalyst solution. The catalyst solution was sprayed on 50 μm thick stainless-steel foil and 8 μm thick copper foil, respectively. The stainless-steel foil and copper foil were dried in a drying oven at 80° C. for 20 minutes and then placed in a furnace. After vacuuming the furnace, methane gas was inlet into the furnace. Then, the furnace was heated from room temperature to 630° C. (heating time 45 minutes) followed by temperature holding of 1 hour. Then, the power supply was turn off to let the furnace cool naturally to 50° C., and then the sample was taken out. The morphology of the composite was observed by scanning electron microscope, and the results are shown in FIG. 26. It can be seen from FIGS. 26a and 26b that the structural carbon deposited on stainless steel is formed by relatively uniform 50 nm flakes and particles. It can be seen from FIGS. 26c and 26d that the structural carbon deposited on copper is formed by mutual bonding of strips about 500 nm wide growing in a specific direction.

### Embodiment 12

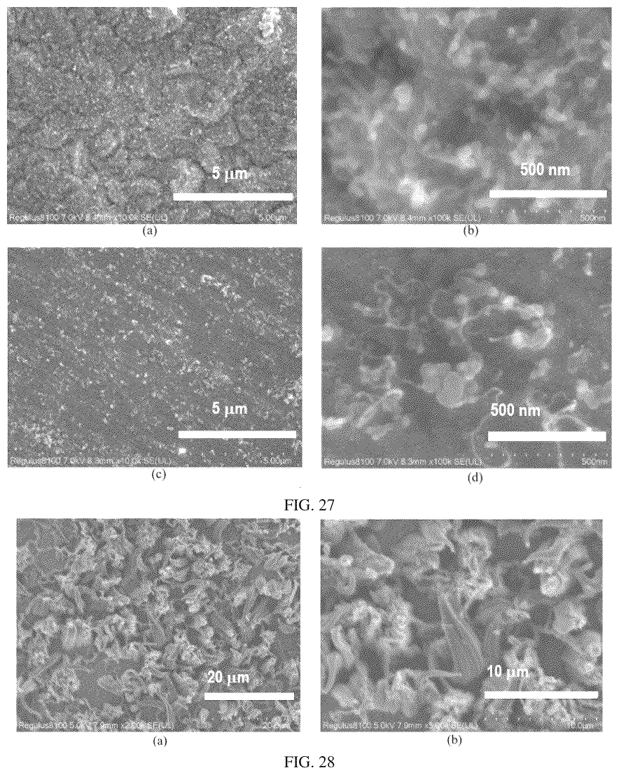

2 g LiCl and 0.4 g of Fe(NO₃)₃ were dissolved into 38 g deionized water to prepare LiCl/Fe(NO₃)₃ catalyst mixture. The mixture was then sprayed onto 8 m copper foil. 2 g LiH₂PO₄ and 0.4 g Fe(NO₃)₃ were dissolved into 37.6 g deionized water to prepare LiH₂PO₄/Fe(NO₃)₃ catalyst mixture, which was sprayed onto 50 m stainless steel foil. Then, the above samples were dried in an 80° C. drying oven for 20 minutes followed by placing the samples in a furnace. After vacuuming the furnace, acetylene gas was inlet into furnace. Then, the furnace was heated to 600° C. (heating time 45 minutes) followed by temperature holding of 1 hour. Then, the furnace was turn off to let it cool to 300° C. followed by vacuuming the furnace. When the furnace temperature was 30° C., the example was taken out for examination. The morphology of the sample was observed by scanning electron microscope, and the results are shown in FIG. 27. It can be seen from FIGS. 27a and 27b that the structural carbon of composite deposited by LiCl/Fe(NO₃)₃ catalyst system consists of a curved carbon fiber with a diameter of about 50 nm, which is intertwined and bonded with each other. It can be seen from FIGS. 27c and 27d that the carbon structure of composites deposited by LiH₂PO₄/Fe(NO₃)₃ catalyst system is consisted of particles with a diameter of about 20 nm which are bonded together forming the main carbon structure with few carbon fibers of about 10 nm in diameter.

### Embodiment 13

2 g MgCl₂ was dissolved into 38 g deionized water to prepare a catalyst mixture. The 8 μm thick copper foil was evenly sprayed with the catalyst mixture followed by drying in a dry oven at 80° C. for 20 minutes. Then, the sample was placed in the furnace, followed by vacuuming the furnace and injecting acetylene gas. The furnace was heated from room temperature to 500° C. (heating time 45 minutes) and the temperature was hold for 1 hour. Then the power was turn off to let the furnace cool naturally. When the temperature of the furnace was 300° C., the furnace was vacuumed and then cooled continually to 30° C. The sample was then taken out of the furnace. The morphology of the sample was observed by scanning electron microscope, and the results are shown in FIG. 28. It can be seen from the figure that the structural carbon of the prepared composite material is mainly composed of better oriented and regular conical structure mixed with a small amount of fibrous carbon.

### Embodiment 14

2 g MgCl₂ was dissolved into 38 g of deionized water to prepare a catalyst mixture. The 20 μm thick nickel foil washed with acetone was evenly sprayed with the catalyst mixture and dried in a drying oven at 80° C. for 20 minutes. Then the sample was placed in the heating furnace followed by vacuuming the furnace and injecting toluene solution. Then, the furnace was heated to 530° C. (heating time 45 minutes) followed by temperature holding for 1 hour. Then, the furnace was turn off to let the furnace cool naturally. When the temperature of the heating furnace was 300° C., the furnace was vacuumed. When the furnace temperature was 30° C., the sample was taken out. The morphology of the sample was observed by scanning electron microscope, and the results are shown in FIG. 29. It can be seen from the figure that the structural carbon of the prepared composite material consists of mainly intertwined carbon fibers with a diameter of about 50 nm and a small amount of special-shaped carbon.

### Embodiment 15

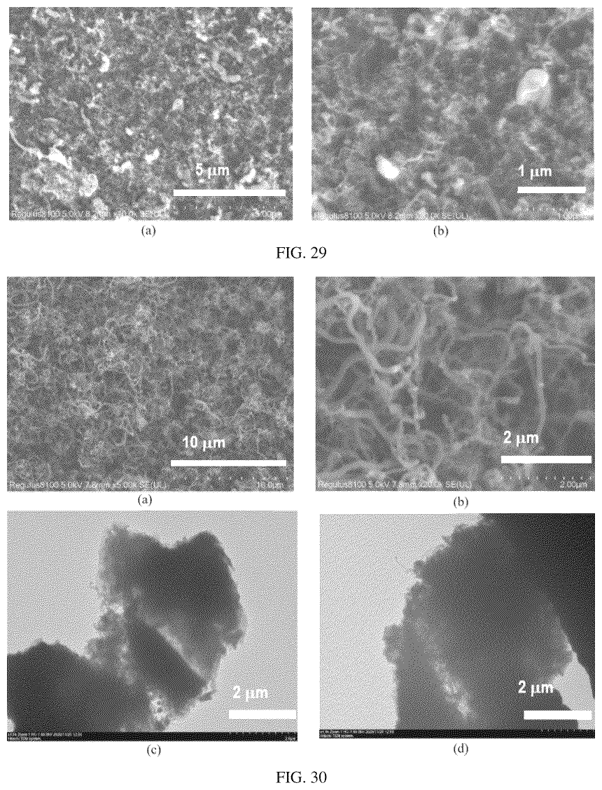

1 g MgCl₂ and 1 g CaCl₂ were dissolved into 38 g deionized water to prepare a catalyst mixture. The 20 μm thick nickel foil washed with acetone was evenly sprayed with the catalyst mixture followed by drying in vacuum oven at 80° C. for 20 minutes. Then the sample was placed in the heating furnace, followed by vacuuming and injecting acetylene gas. Then the furnace was heated from room temperature to 530° C. (heating time 45 minutes) followed by temperature holding for 1 hour. Then the furnace was turn off to let the furnace cool naturally. When the temperature of the heating furnace was 300° C., the furnace was vacuumed. When the furnace temperature was 30° C., the sample was taken out. The morphology of the sample was observed by scanning electron microscope, and the results are shown in FIG. 30. As can be seen from FIGS. 30 (a) and (b), the structural carbon of the prepared composite is mainly linear and helical fibers with a diameter of about 100 nm. The electrode was scraped off the copper foil with a blade, and then observed with transmission electron microscope. It can be seen that the structural carbon is connected together through carbon film, as shown in FIGS. 30c and 30d.

### Embodiment 16

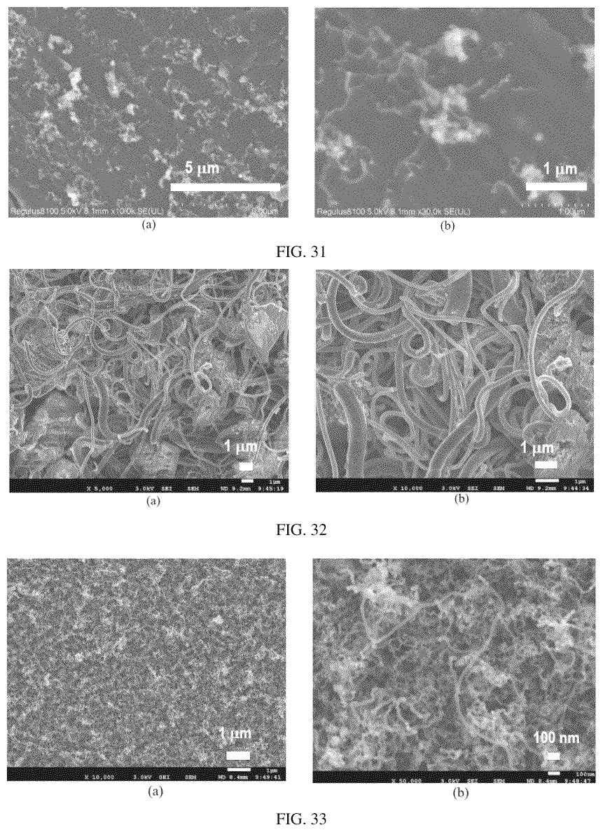

2 g Ba(NO₃)₃ was dissolved into 38 g deionized water to prepare a catalyst mixture. The 20 μm thick nickel foil washed with acetone was evenly sprayed with the catalyst mixture and dried in a vacuum oven at 80° C. for 20 minutes. Then, the sample was placed in the heating furnace followed by vacuuming the heating furnace and injecting toluene liquid. Then the furnace was heated from room temperature to 530° C. (heating time 45 minutes) followed by temperature holding for 1 hour. Then the furnace was turn off to let the furnace cool naturally. When the temperature of the heating furnace was 300° C., the furnace was vacuumed. When the furnace temperature was 30° C., the sample was taken out. The morphology of the sample was observed by scanning electron microscope, and the results are shown in FIG. 31. It can be seen from the figure that the structural carbon of the prepared composites consists of a small amount of granular carbon and fibers with a diameter of 30 to 100 nm.

### Embodiment 17

2 g Ba(NO₃)₃, 20 g LiCl and 0.2 g FeCl₃ and 77.8 g deionized water were mixed to prepare a mixed catalyst solution. 1 g aluminum phosphate powder was dispersed in 10 g mixed catalyst solution to prepare a mixed catalyst suspension of catalyst and solid additives. The copper foil was evenly sprayed with mixed catalyst suspension and dried in at 80° C. vacuum drying oven for 20 minutes. Then, the copper foil was placed in the heating furnace followed by vacuuming and inletting acetylene gas. Then, the heating furnace was heated from room temperature to 550° C. followed by temperature holding for 1 hour. Then, the furnace was turn off to cool the heating furnace to 300° C. Then, the furnace was vacuumed. When the furnace temperature was 30° C., the sample was taken out. The morphology of the sample was observed by scanning electron microscope, and the results are shown in FIG. 32. It can be seen from the figure that the structural carbon is consisted of mainly short fibrous protrusions and the aluminum phosphate powder that is adhered and wound together by long carbon fibers. The diameter of carbon fiber is 200 nm to 500 nm. This structure ensures the surface conductivity of aluminum phosphate powder and good electrical contact between aluminum phosphate and copper substrate composite.

### Embodiment 18

2 g Ba(NO₃)₃, 20 g LiCl and 0.2 g FeCl₃ and 77.8 g deionized water containing 1 wt % of surfactant TX-100 were mixed to prepare a mixed catalyst solution. The graphite paper was evenly sprayed with a thin layer of mixed catalyst solution followed by drying in an 80° C. vacuum oven for 20 minutes. Then, the samples were put into the furnace followed by vacuuming and inletting acetylene gas. Then, the furnace was heated to 550° C. followed by temperature holding for 1 hour. Then the furnace was turn off to let the furnace cool naturally. When the furnace temperature was 300° C., the heating furnace was vacuumed. When the furnace was 30° C., the samples were taken out. The morphology of the sample was observed by scanning electron microscope, and the results are shown in FIG. 33. It can be seen from the figure that the structural carbon consists of carbon fibers with a diameter of about 20 nm, which are intertwined with each other.

### Embodiment 19

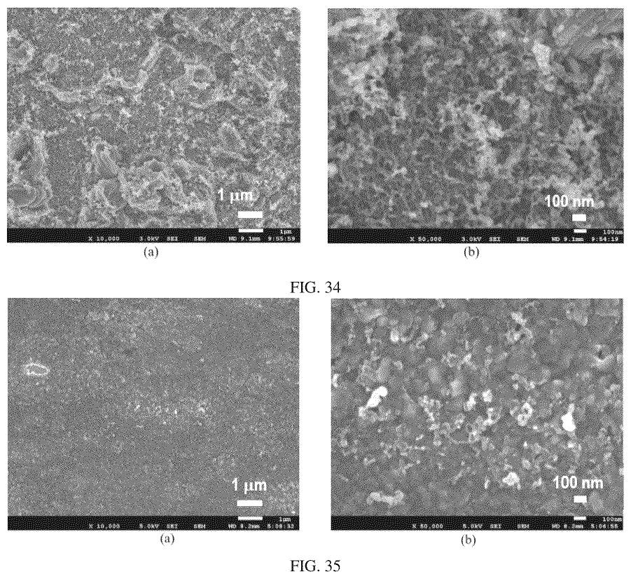

2 g Ba(NO₃)₃, 20 g LiCl, 0.2 g FeCl₃ and 77.8 g deionized water were mixed to prepare a mixed catalyst solution. The copper foil was evenly sprayed with mixed catalyst solution and dried in an 80° C. vacuum drying oven for 20 minutes. Then, the copper foil was placed in the heating furnace followed by vacuuming the heating furnace before passing acetylene gas. The heating furnace was heated from room temperature to 550° C. with a temperature dwell of 1 hour. Then, the furnace was turn off to let it cool naturally. When the temperature of the heating furnace is 300° C., the furnace was vacuumed. When the furnace temperature was 30° C., the samples were taken out. The morphology of the sample was observed by scanning electron microscope, and the results are shown in FIG. 34. It can be seen from the figure that the structural carbon consists of a dead tree pile carbon fiber with a diameter of about 1 m, which is evenly distributed in the intertwined carbon fibers with a diameter of about 20 nm.

### Embodiment 20

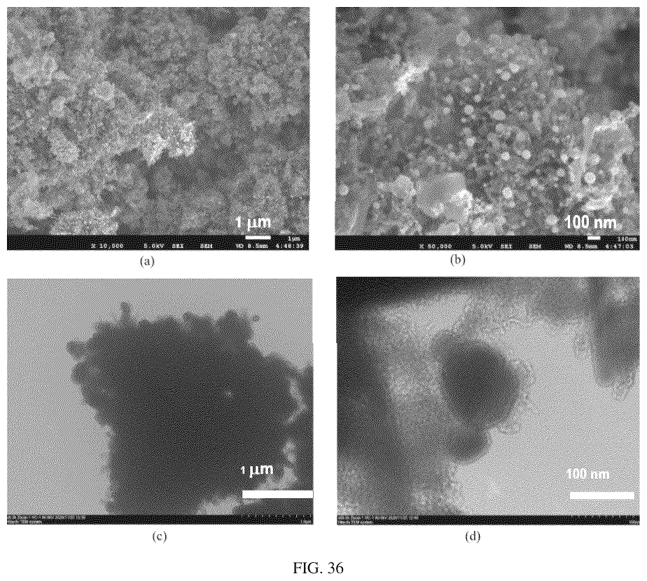

2 g LiCl was dissolved into 98 g deionized water to prepare a 2 wt % catalyst solution. The 100 m thick titanium foil was evenly sprayed with catalyst solution followed by drying in a 100° C. drying oven for 10 minutes. The samples were then put into the heating furnace followed by vacuuming and inletting acetylene gas. The furnace was then heated to 550° C. with a temperature dwell of 1 hour. Then, the furnace was turn off followed by vacuuming the furnace at 300° C. When the furnace was cooled to 30° C., the sample was taken out. The morphology of the sample was observed by scanning electron microscope, and the results are shown in FIG. 35. It can be seen from the figure that the structural carbon consists of granular carbon and very short carbon fibers.

### Embodiment 21

2 g LiCl and 0.2 g FeCl₃ were dissolved into 38 g deionized water to prepare the composite catalyst solution. Then, 5 g CoO powder and 1 g composite catalyst solution were evenly mixed and dried in a 100° C. drying oven for 20 minutes followed by grinding with an appropriate number of polypropylene particles to prepare the reaction precursor. Then, the reaction precursor was put into the heating furnace followed by vacuuming and introducing nitrogen. The heating furnace was then heated to 600° C. with a temperature dwell of 1 hour. The furnace was then turn off followed by vacuuming at 300° C. When the temperature of the heating furnace was 30° C., the samples were taken out. The morphology of the sample was observed by scanning electron microscope, and the results are shown in FIG. 36. It can be seen from the figure that there are short fibers of about 20 nm in diameter deposited on the surface of CoO particles. The carbon film and structural carbon on the surface of CoO substrate can be seen by transmission electron microscope. The thickness of the carbon film is about 20 nm, and the structural carbon consists of short carbon nanotube and anisotropic carbon, as shown in FIGS. 36c and 36d. The experimental results also show that the electrical conductivity between prepared CoO substrate composite materials is very good.

### Embodiment 22

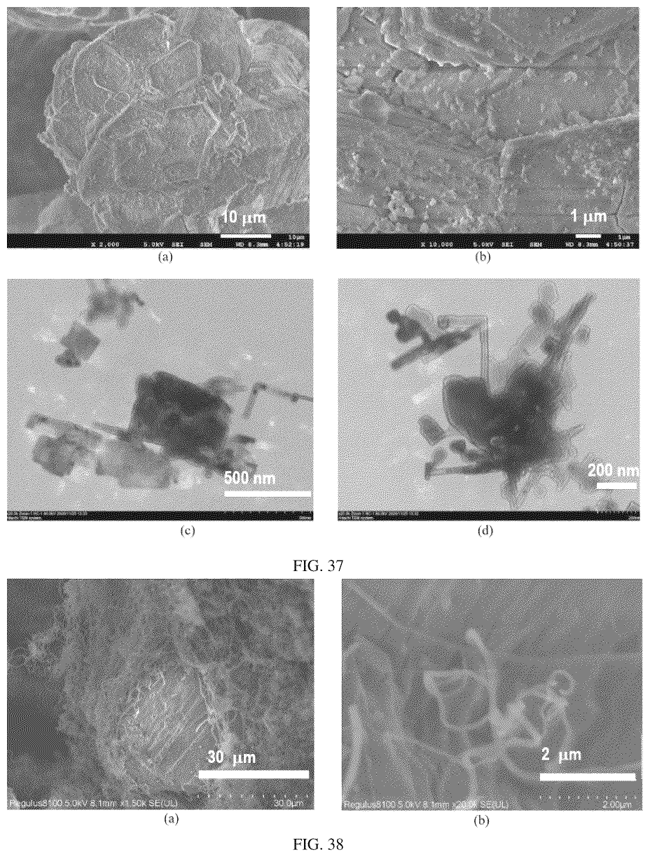

2 g LiCl and 0.2 g FeCl₃ were dissolved into 38 g of deionized water to prepare the catalyst solution. Then, 5 g A1₂O₃ powder and 1 g catalyst solution were evenly mixed and dried in a 100° C. drying oven for 20 minutes. The dried material was ground into powder followed by mixing with an appropriate amount of unsaturated fatty acid. Then, the sample was put into the furnace followed by vacuuming and inletting nitrogen. Then, the furnace was heated to 600° C. followed by temperature holding for 1 hour. Then, the furnace was turn off followed by vacuuming the furnace at 300° C. When the furnace temperature was 30° C., the sample was taken out. The morphology of the sample was observed by scanning electron microscope. The results are shown in FIGS. 37a and 37b. The structural carbon of particulate was deposited on Al₂O₃ particles. The samples were observed by transmission electron microscope as shown in FIGS. 37c and 37d. The thickness of carbon film on the surface of Al₂O₃ particles is about 15 nm, and the structural carbon consists of irregular protrusions and tubes. The experimental results also show that the prepared Al₂O₃ substrate composite material have good electrical conductivity.

### Embodiment 23

1 g LiCl, 0.2 g CuCl₂ and 0.2 g nickel acetate were dissolved into 38 g of deionized water to prepare the composite catalyst solution. Then, 5 g Al₂O₃ powder and 1 g composite catalyst solution were evenly mixed and dried in a 100° C. drying oven for 60 minutes. The dried material was ground into powder for use. Then, the samples were put into the heating furnace followed by heating the furnace to 500° C. Then, the furnace was vacuumed followed by inletting acetylene. The furnace temperature was kept at 500° C. for 1 hour followed by turning off the furnace. When the furnace was cooled to 30° C., the sample was taken out. The morphology of the sample was observed by scanning electron microscope. The results are shown in FIGS. 38a and 38b. The surface of Al₂O₃ particles is covered with intertwined carbon fibers with a diameter of about 100 nm, and the carbon fibers grow from the carbon film on the surface of Al₂O₃. Al₂O₃ powder was white before reaction and turn grey black after reaction, indicating that the powder surface is coated with a layer of carbon film.

### Embodiment 24

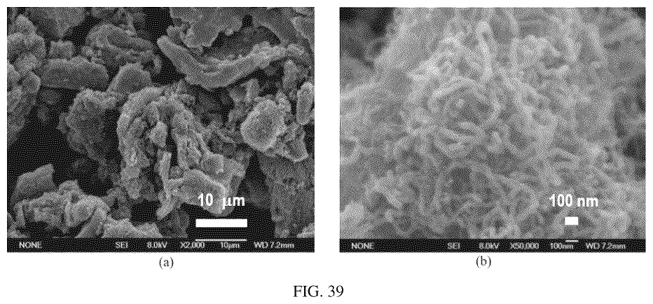

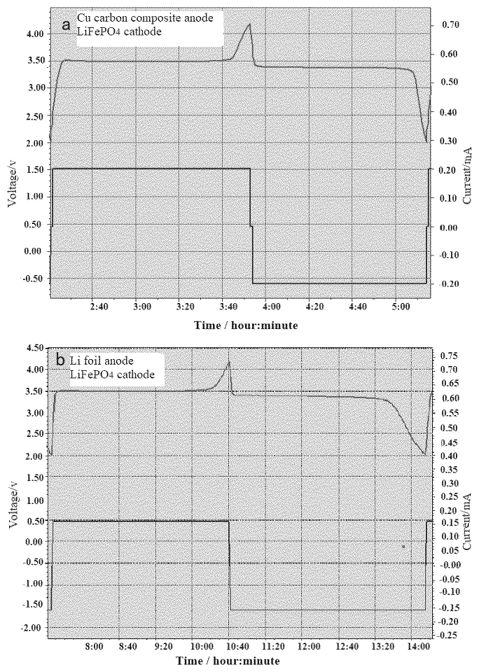

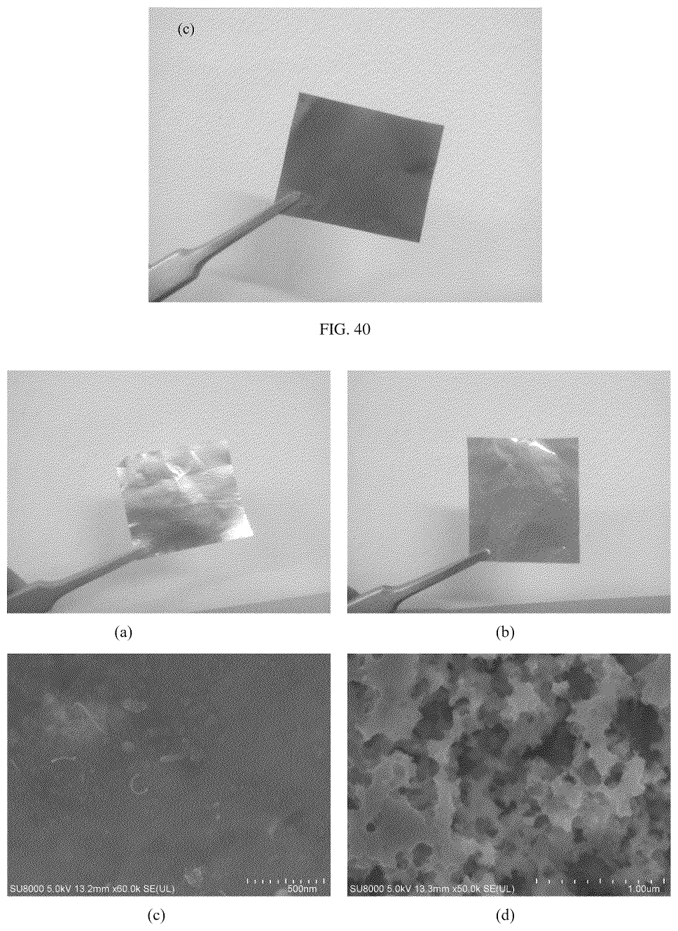

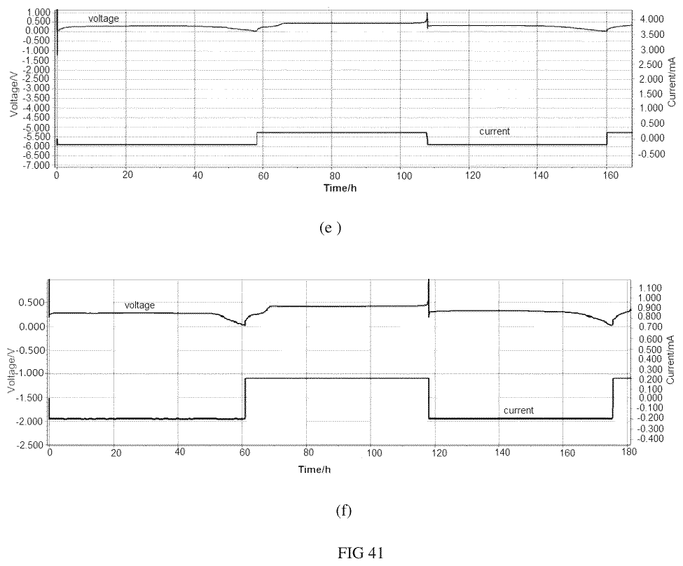

In this experiment, the catalyst was prepared by precursor method. Fumaric acid and calcium hydroxide were mixed and stirred at a molar ratio of 1:1. The obtained solution was dried in a drying oven at 60° C. to obtain a white powder. The powder was ground to obtain a catalyst precursor. Then, the catalyst precursor was calcined in air atmosphere at 700° C. for 1 hour to obtain CaCO₃ catalyst. Then, nitrogen was inlet into the tubular furnace to clean off the air in the tubular furnace to prevent explosion. The furnace was cooled to the deposition temperature 600° C., followed by cutting off nitrogen and inletting acetylene for 1 hour. After the reaction, the furnace was turn off followed by cutting off the acetylene gas and inletting a small amount of hydrogen as protective gas to prevent the deposition products from being oxidized by air. When the heating furnace temperature was 80° C., the sample was taken out. The sample was then observed with scanning electron microscope, and the result is shown in FIG. 39. It can be seen from the figure that carbon fibers with a diameter of about 50 nm grow on the surface of CaCO₃, and the carbon fibers are intertwined with each other.

### Embodiment 25

The electrochemical performance of the prepared composite material as the electrode of lithium-ion battery was tested as follows. The composite material produced by using 8 m copper foil as substrate and LiCl as catalyst was cut into a 14 mm diameter disc. LiFePO₄ powder, conductive graphite and PVDF were prepared into slurry at 85:5:10 mass ratio, and then the slurry was coated on the aluminum foil, followed by vacuum drying at 150° C. for 8 hours to obtain LiFePO₄ positive electrode sheet. The button cells (2025) were assembled in argon (H₂O, O₂<1 ppm) glove box by using LiFePO₄ as cathode, copper substrate composite material and lithium metal as anodes and PP film as separator and 1 M LiPF6 (EC/DMC=1:1) as electrolyte. The constant current charge and discharge performances of button cell were tested with constant current charge and discharge tester. The test conditions are 2-4.2 v and current 50 mA/g. The test results are shown in FIGS. 40a and 40b. The photo of the copper substrate composite is shown in FIG. 40c. The experimental results show that the prepared copper substrate composite material as anode has very good electrochemical properties. The capacity of the carbon film and structural carbon on copper substrate is as high as 12000000 mAh/g, which is 3225 times of theoretical capacity of graphite (372 mAh/g), and 285 times of silicon-carbon anode material (4200 mAh/g). It is then clear that the produced composite electrode has a very large capacity of Li storage. Therefore, the composite electrode can be tens time lighter than prior arts.

### Embodiment 26

1 g LiCi is dissolved in 50 g deionized water to prepare a solution. The solution is sprayed on to the 10 μm thick A1 or Ti foil followed by drying in a 80° C. oven. A piece of the coated A1 foil or Ti foil is placed in a furnace followed by adjusting the furnace temperature to 150° C., and then holding the temperature for 10 minutes. Then, the furnace is vacuumed followed by inletting C₂H₂, followed by adjusting the furnace temperature to 200° C., and holding the temperature for 15 minutes. Then, the furnace is turn off to cool the furnace to room temperature to get the Al substrate composite and Ti substrate composite. FIGS. 41a and 41b show the photo of Al substrate composite and Ti substrate composite respectively. FIGS. 41c and 41d show the SEM photos of Al substrate composite and Ti substrate composite respectively. Al substrate composite shows a smooth surface with small protrusion, and the Ti substrate composite shows a cellular structure. The composites are cut into a disc of 16 millimeter in diameter. A 2025 cell battery was assembled by using the composite as cathode, and a Li foil as anode and LiPF₆ as a electrolyte (1M, EC:DMC=1:1) in a glove box with Ar gas (H₂O, O₂<1 ppm). The charge and discharge of the cell is tested at constant current. (0.01V-1V). The test curves are show FIG. 41e and FIG. 41f. The Al substrate composite has a reversible capacity of 5.2 mAh/cm² (0.02 C) or 16000 mAh/g of single side. The mass of the carbon film and structural carbon of the disc Al substrate composite electrode is 0.32 mg of single side. The Ti substrate composite has a reversible capacity of 5.7 mAh/cm² (0.02 C) or 17000 mAh/g of single side. The mass of the carbon film and structural carbon of the disc Ti substrate composite electrode is 0.33 mg of single side. If a Si—C anode material with 1000 mAh/g capacity, 5.6 mg of Si—C anode material is needed to provide the same capacity of Al substrate or Ti substrate composite electrode of 0.33 mg, which is only 5.9% of Si—C anode material. Therefore, the in-situ produced composite electrode in this invention is much lighter than prior art.

1. A carbon-based composite material comprising substrate, carbon film and structural carbon, wherein:
the carbon film is bonded to a surface of the substrate and the structural carbon is bonded on the carbon film, and the substrate, carbon film and structural carbon are bonded together forming one body;
the carbon-based composite material is any shape and structure;
the substrate comprises solid material with any shape and structure;
the carbon film is continuously or discontinuously covering the substrate;
the carbon film has a film-like structure;
the structural carbon has any shape and structure;
the carbon film and the structural carbon contain carbon element, and one or more kinds of alkali metal elements, or one or more kinds of alkaline earth metal elements;
the alkali metal element comprises Li, Na, K, Rb, Ce or Fr, and the alkaline earth metal element comprises Be, Mg, Ca, Sr, Ba, or Ra.

2. The carbon-based composite material according to claim 1, wherein the carbon film or structural carbon contains one or more of all elements excluding carbon element, alkali metal element and alkaline earth metal element, and the element comprises any matter containing the element, the alkali metal element comprises any matter containing the alkali metal element, the alkaline earth metal element comprises any matter containing the alkaline earth metal element, the all elements comprise all elements in nature.

3. The carbon-based composite material according to claim 1, wherein the carbon-based composite material has a surface area from 0.001 square nanometers to 1 billion square meters; wherein the carbon-based composite material comprises one or more kinds of solid materials, one or more kinds of carbon films or one or more kinds of structural carbons; wherein the substrate has a surface area from 0.001 square nanometers to 1 billion square meters, wherein the carbon film has an average thickness from 0.001 nm to 1 mm.

4. The carbon-based composite material according to claim 1, wherein a content of alkali metal element and alkaline earth metal element in the carbon film is 0 wt %-99.999900000000000 wt % mass of the carbon film, but not to be zero, a content of all elements excluding carbon element, alkali metal element and alkaline earth metal element in the carbon film is 0 wt %-99.999900000000000 wt % mass of the carbon film.

5. The carbon-based composite material according to claim 1, wherein a content of alkali metal element and alkaline earth metal element in the structural carbon is 0 wt %-99.999900000000000 wt % mass of the structural carbon, but not to be zero, a content of all elements excluding carbon element, alkali metal element and alkaline earth metal element in the structural carbon is 0 wt %-99.999900000000000 wt % mass of the structural carbon.

6. The carbon-based composite material according to claim 1, wherein the carbon film and structural carbon modify the solid material generating the carbon-based composite material with a property, and the property comprises one or more of all kind properties of material.

7. A preparation method of the carbon-based composite material according to claim 1, comprising utilizing a catalyst to make a carbon containing source forming the carbon film on the surface of substrate and the structural carbon on the carbon film in an environment comprising vacuum, gas matter, liquid matter or solid matter;
wherein the catalyst comprises one or more of any matter containing alkali metal element or one or more of any matter containing alkaline earth metal element;
wherein the substate comprises one or more of solid materials, and the solid material comprise organic material, inorganic nonmetallic material, or metal;
wherein the carbon containing source comprise carbon, or one or more of carbon containing organic matters;
wherein the gas matter comprises any matter in gas state, the liquid matter comprises any matter in liquid state, and the solid matter comprises any matter in solid state;
wherein the alkali metal element comprises Li, Na, K, Rb, Ce or Fr, and the alkaline earth metal element comprises Be, Mg, Ca, Sr, Ba, or Ra.

8. The preparation method of claim 7, wherein the catalyst is coated on the substrate by any realizable means; or the catalyst is added into organic material, inorganic nonmetallic material or metal by any realizable means for material manufacture to generate a substrate containing catalyst and a content of catalyst in the substrate is 0 wt %-99.99990000000000 wt %, but not to be zero; or the catalyst is added into carbon containing source by any realizable means to generate a carbon containing source containing catalyst and a content of catalyst in the carbon containing source is 0 wt %-99.99990000000000 wt %, but not to be zero.

9. The preparation method of claim 7, wherein the carbon film and structural carbon and substrate are chemically bonded together producing the carbon-based composite material with a mechanical, electrical, optical, electronic, magnetic, phonic, chemistry, chemical, thermal, electromagnetic, semiconducting, insulating, conducting, or superconducting property, and a temperature of the environment is from −272.99° C. to 3000° C.

10. The preparation method of claim 7, comprising following steps:
(A1) the substrate is coated with catalyst or a catalyst mixture followed by not heat treatment or heat treatment in an environment at a temperature of −50° C.-1000° C.;
(A2) the substrate coated with catalyst or the catalyst mixture is placed in a furnace with an environment, followed by controlling the furnace to a temperature of −272.99° C.-3000° C. and then holding the temperature for up to 1000 hours for decomposing, melting, mixing evenly the catalyst mixture or letting the catalyst infiltrate the substrate surface;
(A3) the environment of furnace in step (A2) after reaction is adjusted or not adjusted followed by adjusting the furnace to a temperature of −272.99° C.-3000° C., then not adjusting or adjusting the environment of the furnace, then followed by inletting the carbon containing source into the furnace followed by holding the temperature for up to 1000 hours to let carbon containing source react under the action of the catalyst to form the carbon film on substrate surface and the structural carbon on the carbon film;
(A4) the environment of furnace in step (A3) after reaction is adjusted or not adjusted and the furnace temperature is adjusted to −50° C.-100° C. to obtain the carbon-based composite material;
or
(B1) the substrate coated with catalyst or the catalyst mixture followed by coating the carbon containing source followed by not heat treatment or heat treatment in an environment at a temperature of −50° C.-1000° C. to prepare a reactant, or the substrate coated with the mixture of catalyst mixture and carbon containing source followed by not drying or drying in an environment at a temperature of −50° C.-1000° C. to prepare a reactant, or the substrate is mixed with catalyst mixture and carbon containing source followed by not drying or drying in an environment at a temperature of −50° C.-1000° C. to prepare a reactant;
(B2) the reactant is placed in the furnace with an environment, followed by adjusting the furnace temperature to −272.99° C.-3000° C. and holding the temperature for up to 1000 hours to generate the carbon film on the surface of substrate and the structural carbon on the carbon film;
(B3) the environment of furnace in the step (B2) is not adjusted or adjusted followed by adjusting the furnace temperature to −50-100° C. to obtain the carbon based composite material;
or
(C1) the substrate, the substrate coated with catalyst or the catalyst mixture, or the substrate coated with the catalyst mixture and the carbon containing source is placed in the furnace with an environment containing the catalyst and the carbon containing source followed by adjusting the furnace temperature to −272.99° C.-3000° C., and then holding the temperature for up to 1000 hours to generate the carbon film on the surface of substrate and the structural carbon on the carbon film;
(C2) the environment of the furnace is not adjusted or adjusted, and the furnace temperature is adjusted to −50° C.-100° C. to the obtain carbon-based composite material;
or
(D1) the substrate, the substrate coated with the catalyst mixture or the substrate coated with the catalyst mixture and the carbon containing source is placed in the furnace with an environment following by adjusting the furnace temperature to −272.99° C.-3000° C. and then holding the temperature for up to 1000 hours to decompose, melt or mix the catalyst mixture or let the catalyst infiltrate the substrate surface;
(D2) the environment of furnace is adjusted or not adjusted followed by adjusting the furnace temperature to a temperature of −272.99° C.-3000° C., and then inletting the catalyst and the carbon containing source into the furnace, then adjusting the furnace temperature to −272.99° C.-3000° C. followed by holding the temperature for up to 1000 hours to generate the carbon film on the surface of substrate and the structural carbon on the carbon film;
(D3) the environment of the furnace is not adjusted or adjusted, and the furnace temperature is adjusted to −50° C.-100° C. to the obtain carbon-based composite material;
in above steps (A1), (A2), (A3) and (A4); (B1), (B2) and (B3); (C1) and (C2); (D1), (D2) and (D3):
when the environment of furnace required between adjacent steps is consistent, the adjustment of environment of furnace in subsequent steps is omitted;
wherein one or more of the steps can be repeated with change or without change of step parameters;
wherein the environment comprises vacuum, air, oxygen, inert gas, hydrogen, ammonia, organic species, or inorganic species, or metallic species;
wherein the organic species comprises one or more of all organic matter, and the inorganic species comprises one or more of all inorganic matter, and the metallic species comprises one or more of all metallic matter;
wherein the catalyst mixture comprises the catalyst of any matter state;
wherein all steps can be carried out under mechanical pressure or atmospheric pressure.

11. The preparation method of claim 10, wherein the substrate to be coated is cleaned by any method followed by heat treatment in a required environment at a temperature of −50° C.-1000° C. for up to 1000 hours; then the substrate surface is continuously or discontinuously coated with the catalyst or the catalyst mixture by using any realizable methods followed by not heat treatment or heat treatment in required environment at a temperature of −50° C.-1000° C. for up to 1000 hours.

12. The preparation method of claim 10, wherein the catalyst mixture comprises gas, solution, suspension, paste, powder or solid of the catalyst, the content of the catalyst in the catalyst mixture is 0.00000000001 wt %-99.99 wt %, the solution, suspension or paste is organic-based, inorganic-based or organic and inorganic mixed-based.

13. The preparation method of claim 10, wherein the catalyst mixture comprises additive, surfactant or thickener; the additive comprise one or more of all materials for producing the carbon film or structural carbon or a carbon-based composite material; a mass fraction of the additive, surfactant or thickeners in the catalyst mixture is 0 wt %-99.999900000000 wt %.
